(19) United States
(12) Patent Application Publication
(10) Pub. No.: US 2021/0347384 A1
(43) Pub. Date: Nov. 11, 2021

(54) MOVING BODY, METHOD OF CONTROLLING MOVING BODY, AND PROGRAM

(71) Applicant: SONY CORPORATION, Tokyo (JP)

(72) Inventors: KAZUO HONGO, TOKYO (JP); YOSHINAO SODEYAMA, TOKYO (JP); HIROKI SAIJO, TOKYO (JP)

(21) Appl. No.: 17/281,165

(22) PCT Filed: Oct. 3, 2019
(86) PCT No.: PCT/JP2019/039102

§ 371 Date: Mar. 29, 2021

(30) Foreign Application Priority Data
Oct. 9, 2018 (JP) 2018-191182

(51) Int. Cl. B60W 60/00; G05D 1/02; B25J 5/00; B25J 9/16; B25J 15/00; B60R 5/04

(52) U.S. Cl. CPC B60W 60/0025; G05D 1/021; B25J 5/007; B60W 2300/40; B25J 15/00; B60R 5/04; G05D 2201/0216; B25J 9/162

(57) ABSTRACT

A moving body (1) includes: a main body (2) having an opening (17); and a control unit that performs control so that the main body (2) moves in a moving space in a state where at least a part of an object existing in the moving space is inserted to the opening (17).

### FIELD

The present disclosure relates to a moving body, a method of controlling a moving body, and a program.

### BACKGROUND

In the technical field related to robots, a mobile trolley and a mobile robot including a manipulator mounted on the mobile trolley are known.

### CITATION LIST

### Patent Literature

Patent Literature 1: Japanese Patent Application Laid-open No. 2004-230509

### SUMMARY

### Technical Problem

A mobile robot is more likely to fall when a footprint indicating the occupied area of a mobile trolley is small. On the other hand, if the footprint of the mobile trolley is large, it becomes difficult for the mobile robot to pass through a moving space when an object such as an obstacle exists in the moving space of the mobile robot.

Therefore, the present disclosure proposes a moving body capable of passing through a narrow moving space, a method of controlling a moving body, and a program.

### Solution to Problem

According to the present disclosure, a moving body includes a main body having an opening; and a control unit that performs control so that the main body moves in a moving space in a state where at least a part of an object existing in the moving space is inserted to the opening.

### BRIEF DESCRIPTION OF DRAWINGS

FIG. 1 is a diagram illustrating an example of a moving body according to a first embodiment of the present disclosure.

FIG. 2 is a diagram illustrating an example of a relationship between the moving body and a moving space according to the first embodiment of the present disclosure.

FIG. 3 is a diagram illustrating an example of a relationship between the moving body and the moving space in which an object exists according to the first embodiment of the present disclosure.

FIG. 4 is a diagram illustrating an example of operation of the moving body according to the first embodiment of the present disclosure.

FIG. 5 is a functional block diagram illustrating an example of a control device according to the first embodiment of the present disclosure.

FIG. 6 is a diagram illustrating an example of operation of a robot arm according to the first embodiment of the present disclosure.

FIG. 7 is a flowchart illustrating an example of a method of controlling the moving body according to the first embodiment of the present disclosure.

FIG. 8 is a diagram illustrating an example of operation of a moving body according to a first modification of the first embodiment of the present disclosure.

FIG. 9 is a diagram illustrating an example of operation of a moving body according to a second modification of the first embodiment of the present disclosure.

FIG. 10 is a diagram illustrating an example of a moving body according to a third modification of the first embodiment of the present disclosure.

FIG. 11 is a diagram illustrating an example of a moving body according to a fourth modification of the first embodiment of the present disclosure.

FIG. 12 is a diagram illustrating an example of a moving body according to a fifth modification of the first embodiment of the present disclosure.

FIG. 13 is a diagram illustrating an example of a moving body according to a sixth modification of the first embodiment of the present disclosure.

FIG. 14 is a functional block diagram illustrating an example of a control device according to a seventh modification of the first embodiment of the present disclosure.

FIG. 15 is a diagram illustrating an example of a moving body and an object according to a second embodiment of the present disclosure.

FIG. 16 is a flowchart illustrating an example of a method of controlling the moving body according to the second embodiment of the present disclosure.

FIG. 17 is a diagram illustrating an example of operation of the moving body according to the second embodiment of the present disclosure.

FIG. 18 is a diagram illustrating an example of a moving body according to a first modification of the second embodiment of the present disclosure.

FIG. 19 is a diagram illustrating an example of operation of a moving body according to the first modification of the second embodiment of the present disclosure.

FIG. 20 is a diagram illustrating an example of operation of a moving body according to a second modification of the second embodiment of the present disclosure.

FIG. 21 is a diagram illustrating an example of a moving body and an external moving body according to a third modification of the second embodiment of the present disclosure.

FIG. 22 is a diagram illustrating an example of a moving body according to another embodiment of the present disclosure.

FIG. 23 is a diagram illustrating an example of a moving body according to another embodiment of the present disclosure.

FIG. 24 is a diagram illustrating an example of a moving body according to another embodiment of the present disclosure.

FIG. 25 is a hardware configuration diagram illustrating an example of a computer that achieves functions of a control device.

### DESCRIPTION OF EMBODIMENTS

Hereinafter, embodiments of the present disclosure will be described in detail with reference to the drawings. In each of the embodiments below, the same components are designated by the same reference numerals, so that duplicate description will be omitted.

The present disclosure will be described according to the order of items shown below.

### 1. First Embodiment

1-1. Configuration of moving body according to first embodiment

1-2. Configuration of control device according to first embodiment

1-3. Procedure of method of controlling moving body according to first embodiment

1-4. Effects of first embodiment

2. First modification of first embodiment

3. Second modification of first embodiment

4. Third modification of first embodiment

5. Fourth modification of first embodiment

6. Fifth modification of first embodiment

7. Sixth modification of first embodiment

8. Seventh modification of first embodiment

9. Second Embodiment

9-1. Configuration of moving body according to second embodiment

9-2. Procedure of method of controlling moving body according to second embodiment

9-3. Effects of second embodiment

10. First modification of second embodiment

11. Second modification of second embodiment

12. Third modification of second embodiment

13. Other embodiments

14. Hardware configuration

### 1. First Embodiment

### 1-1. Configuration of Moving Body According to First Embodiment

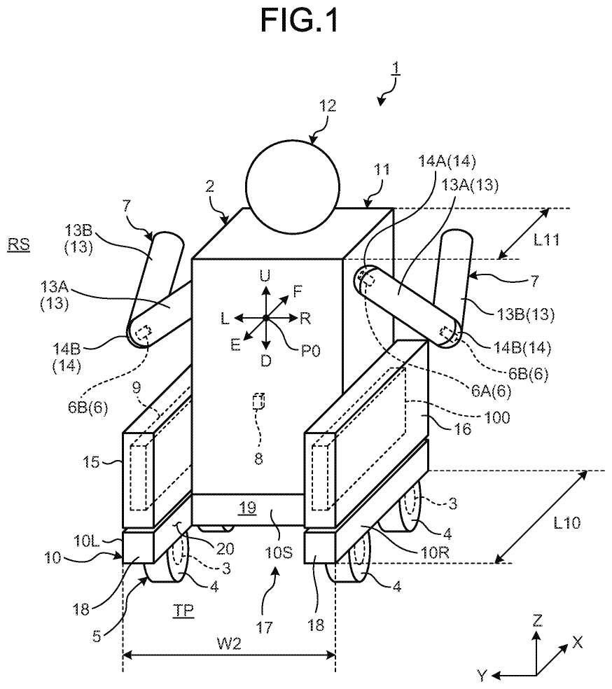

FIG. 1 is a diagram illustrating an example of a moving body 1 according to a first embodiment of the present disclosure. The moving body 1 moves in a moving space RS. The moving body 1 is a mobile robot that is movable in the moving space RS. The moving body 1 autonomously travels in the moving space RS.

In the description below, the XYZ Cartesian coordinate system is set in the moving space RS, and the positional relationship of parts will be described with reference to the XYZ Cartesian coordinate system. The XYZ Cartesian coordinate system is a local coordinate system set in the moving space RS. The direction parallel to the X-axis in a first predetermined surface is an X-axis direction. The direction parallel to the Y-axis in the first predetermined surface orthogonal to the X-axis is a Y-axis direction. The direction parallel to the Z-axis orthogonal to the first predetermined surface is a Z-axis direction. The direction of rotation or inclination about the X-axis is a θX direction. The direction of rotation or inclination about the Y-axis is a θY direction. The direction of rotation or inclination about the Z-axis is a θZ direction. The first predetermined surface including the X-axis and the Y-axis is appropriately referred to as an XY plane. The second predetermined surface including the X-axis and the Z-axis is appropriately referred to as an XZ plane. The third predetermined surface including the Y-axis and the Z-axis is appropriately referred to as a YZ plane. The XY plane and the XZ plane are orthogonal. The XY plane and the YZ plane are orthogonal. The XY plane is parallel to the horizontal surface. The XY plane may be inclined with respect to the horizontal surface.

In the description below, the positional relationship of parts of the moving body 1 will be described by defining three directions of the front-rear direction, the width direction, and the vertical direction with respect to a main body 2 of the moving body 1. In the example illustrated in FIG. 1, a +X direction is front F of the main body 2. A −X direction is rear E of the main body 2. A +Y direction is left L of the main body 2. A −Y direction is right R of the main body 2. A +Z direction is upper U of the main body 2. A −Z direction is lower D of the main body 2.

As illustrated in FIG. 1, the moving body 1 includes the main body 2, a traveling device 5 having a traveling motor 3 and wheels 4, a robot arm 7 having an arm actuator 6, a position sensor 8, a battery 9, and a control device 100.

The main body 2 has a frame part 10 to which the traveling device 5 is mounted, a trunk part 11 supported by the frame part 10 and to which the robot arm 7 is coupled, and a head part 12 supported by the trunk part 11.

The frame part 10 is connected to the lower part of the trunk part 11. The frame part 10 includes a left frame 10L arranged to the left of the trunk part 11 in the width direction, a right frame 10R arranged to the right of the trunk part 11 in the width direction, and a support frame 10S connected to each of the left frame 10L and the right frame 10R. Each of the left frame 10L and the right frame 10R extends in the front-rear direction. The support frame 10S extends in the width direction. The left end of the support frame 10S and the left frame 10L are connected. The right end of the support frame 10S and the right frame 10R are connected. The support frame 10S is arranged in front of the centers of the left frame 10L and the right frame 10R in the front-rear direction.

The trunk part 11 is supported by the support frame 10S. The trunk part 11 is long in the vertical direction. In the front-rear direction, a dimension L11 of the trunk part 11 is smaller than a dimension L10 of the frame part 10. The trunk part 11 is arranged in front of the center of the frame part 10 in the front-rear direction.

The dimension L11 in the front-rear direction of the trunk part 11 is smaller than a dimension W2 in the width direction of the main body 2. The dimension W2 is the maximum value of the dimension in the width direction of the main body 2. In the present disclosure, the dimension W2 is the distance between the left end of the left frame 10L and the right end of the right frame 10R.

The head part 12 is connected to the upper part of the trunk part 11. The head part 12 is rotatably supported by the trunk part 11. The outer shape of the head part 12 is smaller than the outer shape of the trunk part 11 in each of the front-rear direction and the width direction. In each of the front-rear direction and the width direction, the center of the head part 12 and the center of the trunk part 11 substantially coincide with each other.

The traveling device 5 supports the main body 2 and travels on a moving surface TP of the moving space RS. The moving surface TP is parallel to the XY plane. At least a part of the traveling device 5 is mounted to the frame part 10. As the traveling device 5 travels on the moving surface TP, the main body 2 moves in the moving space RS. The traveling device 5 has wheels 4 that are rotated by a driving force generated by the traveling motor 3. As the wheels 4 rotate, the traveling device 5 travels on the moving surface TP.

The traveling device 5 has four wheels 4. Two wheels 4 are rotatably supported by the left frame 10L. Two wheels 4 are rotatably supported by the right frame 10R. In the left frame 10L, the two wheels 4 are arranged in the front-rear direction. In the right frame 10R, the two wheels 4 are arranged in the front-rear direction.

Wheel 4 is an omnidirectional moving wheel. The omnidirectional moving wheel means a wheel capable of moving the main body 2 in any direction in the XY plane. Since the traveling device 5 has the omnidirectional moving wheels, the main body 2 can move in three directions of the X-axis direction, the Y-axis direction, and the θZ direction on the moving surface TP.

The dimension of the frame part 10 is larger than the dimension of the trunk part 11 in each of the front-rear direction and the width direction. The footprint indicating the occupied area of the traveling device 5 in the XY plane is larger than the occupied area of the trunk part 11 in the XY plane. The footprint of the traveling device 5 is defined by a virtual line connecting the outer edges of the traveling device 5 in the XY plane. In the present disclosure, the footprint of the traveling device 5 is defined by a virtual line connecting the four wheels 4. Since the footprint of the traveling device 5 is large, the moving body 1 is prevented from falling.

The robot arm 7 includes an articulated robot arm. The robot arm 7 is coupled to each of the left side and the right side of the trunk part 11. The robot arm 7 is operated by a driving force generated by the arm actuator 6.

The robot arm 7 has a plurality of links 13 and a plurality of joints 14. The link 13 includes a first link 13A and a second link 13B. The joint 14 includes a first joint 14A that couples the first link 13A and the trunk part 11, and a second joint 14B that couples the first link 13A and the second link 13B.

The arm actuator 6 generates a driving force for operating the link 13. A servo motor is exemplified as the arm actuator 6. The arm actuator 6 includes a first arm actuator 6A that generates a driving force that operates the first link 13A, and a second arm actuator 6B that generates a driving force that operates the second link 13B. The first arm actuator 6A is driven, so that the first link 13A is operated. The second arm actuator 6B is driven, so that the second link 13B is operated.

The position sensor 8 detects the position of the moving body 1 in the moving space RS. The position sensor 8 is provided on the trunk part 11. The position sensor 8 detects a reference position PO of the moving body 1 set in the trunk part 11. As the position sensor 8, a global navigation satellite system (GNSS) sensor that detects the position of the moving body 1 by using the GNSS is exemplified. Note that, a gyro sensor may be used as the position sensor 8. As the position sensor 8, at least one of a laser sensor and a radar sensor that detects the position of the moving body 1 by detecting the position relative to a reference member provided in the moving space RS may be used. As the position sensor 8, a camera sensor that estimates the position of the moving body 1 by acquiring image data of a structure existing in the moving space RS may be used. As the position sensor 8, a pulse sensor that estimates the position of the moving body 1 by detecting the rotation speed of the wheel 4 may be used.

The battery 9 supplies electric power to the electronic device mounted on the moving body 1. The battery 9 supplies electric power to each of the traveling motor 3, the arm actuator 6, the position sensor 8, and the control device 100. The battery 9 is housed in a battery housing 15. The battery housing 15 is connected to the upper part of the left frame 10L.

The control device 100 includes a computer system that controls the moving body 1. The control device 100 is mounted on the moving body 1. The control device 100 is housed in a control housing 16. The control housing 16 is connected to the upper part of the right frame 10R.

The main body 2 has an opening 17 into which at least a part of an object B existing in the moving space RS is inserted. The opening 17 is provided in at least a part of an outer surface 18 of the main body 2.

The opening 17 is provided in the frame part 10. The opening 17 is provided at the rear portion of the frame part 10. In the present disclosure, the outer surface 18 includes the rear end surface of the frame part 10. At least a part of the opening 17 is defined between the rear end surface of the left frame 10L and the rear end surface of the right frame 10R.

The main body 2 has an insertion space 19 in which the object B inserted in the opening 17 is arranged. The insertion space 19 is connected to the opening 17. An inner surface 20 of the main body 2 that defines the insertion space 19 faces the insertion space 19. In the present disclosure, the inner surface 20 that defines the insertion space 19 includes the right surface of the left frame 10L, the left surface of the right frame 10R, and the rear surface of the support frame 10S. The inner surface 20 may include at least a part of the right surface of the battery housing 15, the left surface of the control housing 16, and the rear surface of the trunk part 11. The upper part of the insertion space 19 is opened. The constituent members of the moving body 1 are not arranged above the insertion space 19.

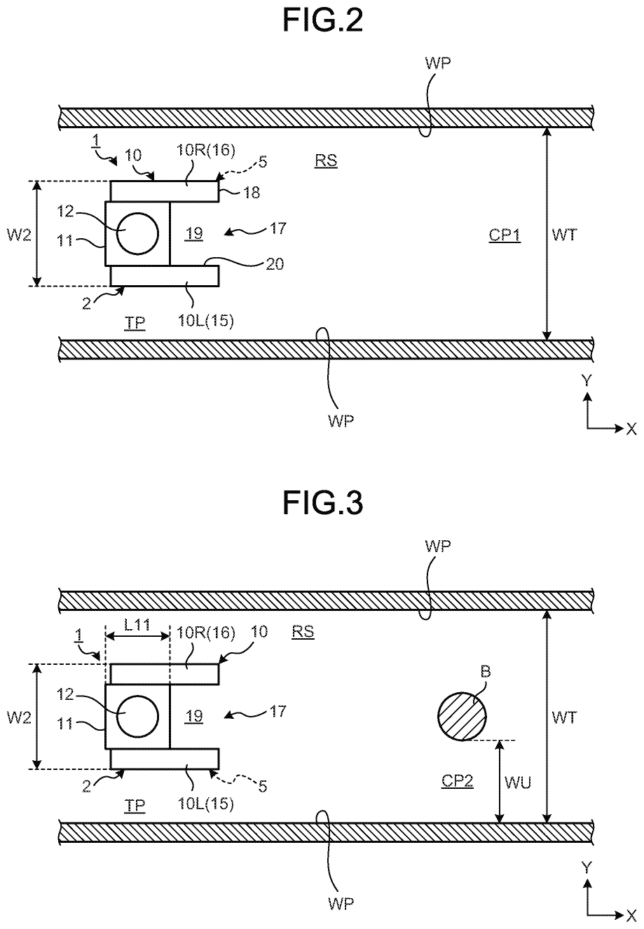

FIG. 2 is a diagram illustrating an example of a relationship between the moving body 1 and the moving space RS according to the first embodiment of the present disclosure. The control device 100 controls the traveling device 5 so that the moving body 1 moves in the moving space RS. In the example illustrated in FIG. 2, the moving space RS extends in the X-axis direction. The control device 100 controls the traveling device 5 so that the moving body 1 moves in the moving space RS in the +X direction.

The moving space RS is defined by the moving surface TP parallel to the XY plane and a pair of wall surfaces WP. The wall surface WP is parallel to the XZ plane. The pair of wall surfaces WP face each other through a gap. The dimension WT of the moving space RS in the Y-axis direction is larger than the dimension W2 in the width direction of the main body 2. The dimension WT is the distance between the pair of wall surfaces WP. That is, in the example illustrated in FIG. 2, in the moving space RS, there is a first space CP1 having a dimension WT larger than the dimension W2 in the width direction of the main body 2. Since the dimension WT is larger than the dimension W2, the moving body 1 can pass through the moving space RS while traveling straight.

FIG. 3 is a diagram illustrating an example of a relationship between the moving body 1 and the moving space RS in which the object B exists according to the first embodiment of the present disclosure. As illustrated in FIG. 3, the object B may exist in the moving space RS. An obstacle such as a pillar is exemplified as the object B. The position of the object B is fixed in the moving space RS. The object B is fixed to at least the moving surface TP. In the example illustrated in FIG. 3, the object B exists in the central portion of the moving space RS in the Y-axis direction. The distance WU between the object B and the wall surface WP in the Y-axis direction is smaller than the dimension W2 in the width direction of the main body 2. In the moving space RS, there is no first space CP1 around the object B through which the moving body 1 traveling straight can pass.

The distance WU is larger than the dimension L11 in the front-rear direction of the trunk part 11. Around the object B, there is a second space CP2 through which the main body 2 can pass by inserting at least a part of the object B into the opening 17.

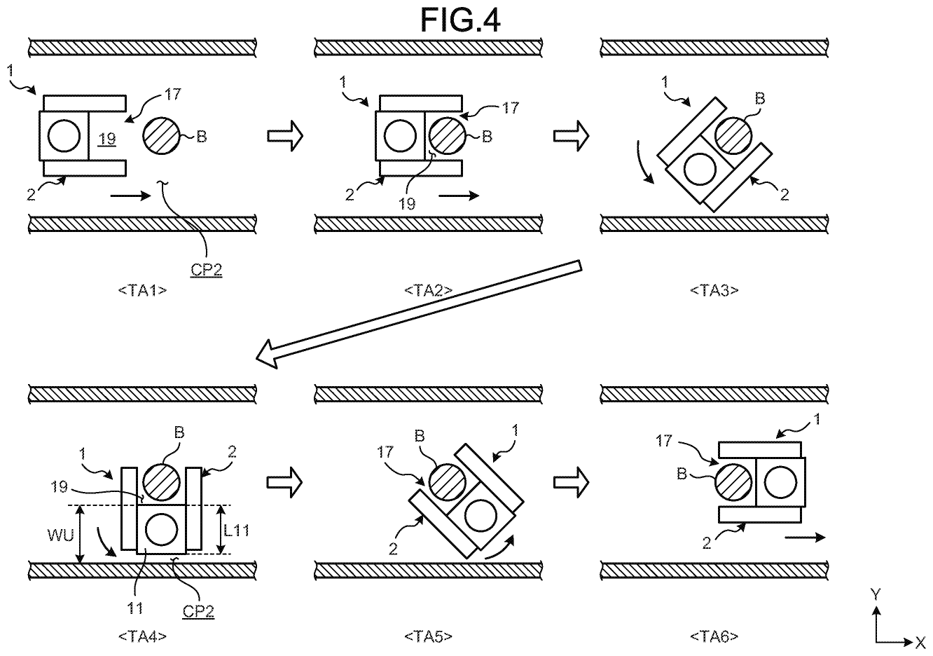

FIG. 4 is a diagram illustrating an example of operation of the moving body 1 according to the first embodiment of the present disclosure. FIG. 4 is a state transition diagram illustrating the state of the moving body 1 when the second space CP2 exists around the object B.

When the second space CP2 exists around the object B, the state of the moving body 1 traveling straight in the moving space RS in the +X direction transitions to a first state TA1 in which the moving body 1 approaches the object B with the opening 17 of the main body 2 and the object B facing each other.

The moving body 1 moves in the +X direction so as to approach the object B with the opening 17 and the object B facing each other, so that at least a part of the object B is inserted to the opening 17. The object B is inserted to the opening 17 so as to overlap at least a part of the main body 2 in the XZ plane. After at least a part of the object B is inserted to the opening 17, the moving body 1 further moves in the +X direction, so that the state of the moving body 1 transitions to a second state TA2 where the object B is arranged in the insertion space 19.

After the object B is arranged in the insertion space 19, the state of the moving body 1 transitions in the order of a third state TA3, a fourth state TA4, and a fifth state TA5, which turn around at least a part of the periphery of the object B.

The third state TA3 indicates the state immediately after the moving body 1 starts turning. The fourth state TA4 indicates the state where the trunk part 11 is arranged in the second space CP2 by the turning of the moving body 1. The distance WU is larger than the dimension L11 of the trunk part 11. Therefore, the trunk part 11 that turns around the object B can pass through the second space CP2. The fifth state TA5 indicates the state immediately before the end of the turning of the moving body 1. The moving body 1 turns around at least a part of the periphery of the object B until the opening 17 faces the −X direction.

After the turning ends, the state of the moving body 1 transitions to the sixth state TA6 where the moving body 1 moves in the +X direction away from the object B. The moving body 1 moves in the +X direction with the opening 17 facing the −X direction, so that the object B is arranged outside the insertion space 19.

As described above, the control device 100 controls the moving body 1 to move in the moving space RS in a state where at least a part of the object B existing in the moving space RS is inserted to the opening 17. As a result, when the object B exists in the moving space RS of the moving body 1, the moving body 1 can smoothly pass through the moving space RS even if the footprint of the traveling device 5 is large.

### 1-2. Configuration of Control Device According to First Embodiment

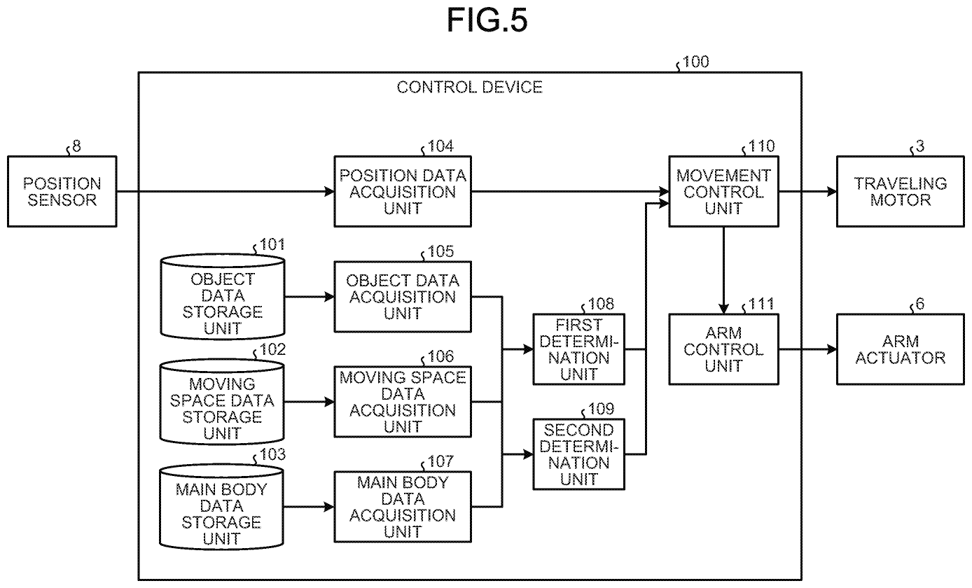

FIG. 5 is a functional block diagram illustrating an example of the control device 100 according to the first embodiment of the present disclosure. The control device 100 includes an object data storage unit 101, a moving space data storage unit 102, a main body data storage unit 103, a position data acquisition unit 104, an object data acquisition unit 105, a moving space data acquisition unit 106, a main body data acquisition unit 107, a first determination unit 108, a second determination unit 109, a movement control unit 110, and an arm control unit 111.

The object data storage unit 101 stores object data related to the object B. The object data includes at least one of the position, dimension, and outer shape of the object B in the XY plane. The object data can be acquired, for example, by conducting a preliminary survey of the object B existing in the moving space RS. The object data may be acquired based on design data of the object B. The object data is stored in advance in the object data storage unit 101.

The moving space data storage unit 102 stores moving space data related to the moving space RS. The moving space data includes at least one of the dimension of the moving space RS and the shape of the wall surface WP. In the present disclosure, the moving space data includes the dimension WT of the moving space RS in the Y-axis direction. The moving space data can be acquired, for example, by conducting a preliminary survey of the moving space RS. The moving space data may be acquired based on design data of the moving space RS. The moving space data is stored in advance in the moving space data storage unit 102.

The main body data storage unit 103 stores main body data related to the main body 2. The main body data includes at least one of the dimension and the outer shape of the main body 2. In the present disclosure, the main body data includes at least one of the dimension W2 of the main body 2 in the width direction, the dimension W11 of the trunk part 11 in the front-rear direction, and the dimension L10 of the frame part 10 in the front-rear direction. The main body data can be acquired, for example, by conducting a preliminary survey of the main body 2. The main body data may be acquired based on the design data of the main body 2. The main body data is stored in advance in the main body data storage unit 103.

The position data acquisition unit 104 acquires detection data of the position sensor 8. The detection data of the position sensor 8 includes reference position data indicating a reference position PO of the moving body 1.

The object data acquisition unit 105 acquires object data from the object data storage unit 101.

The moving space data acquisition unit 106 acquires moving space data from the moving space data storage unit 102.

The main body data acquisition unit 107 acquires main body data from the main body data storage unit 103.

The first determination unit 108 determines whether the first space CP1 larger than the dimension W2 of the main body 2 in the width direction exists in the moving space RS based on the object data, the moving space data, and the main body data. The first space CP1 is a space through which the moving body 1 can pass without inserting the object B into the opening 17. When determining that the object B does not exist in the moving space RS, the first determination unit 108 determines that the first space CP1 exists in the moving space RS. When determining that the object B exists in the moving space RS but the distance WU is larger than the dimension W2, the first determination unit 108 determines that the first space CP1 through which the main body 2 traveling straight can pass exists around the object B.

The second determination unit 109 determines whether the second space CP2 through which the main body 2 can pass when at least a part of the object B is inserted to the opening 17 exists around the object B based on the object data, the moving space data, and the main body data. When determining that the distance WU is smaller than the dimension W2, but the distance WU is larger than the dimension L11, and the main body 2 can pass through the moving space RS when the object B is inserted to the opening 17, the second determination unit 109 determines that the second space CP2 through which the main body 2 can pass exists around the object B.

The movement control unit 110 outputs a movement command so that the moving body 1 moves according to a target path of the moving space RS based on the position data of the moving body 1 detected by the position sensor 8. When the second space CP2 exists around the object B, the movement control unit 110 controls the main body 2 to move in the moving space RS with at least a part of the object B inserted in the opening 17. The movement control unit 110 outputs a movement command to the traveling motor 3 of the traveling device 5 so that the main body 2 moves in the moving space RS.

As described with reference to FIG. 4, the movement control unit 110 can output a movement command so that main body 2 turns around at least a part of the periphery of the object B with at least a part of the object B inserted in the opening 17.

When it is determined that the moving body 1 can pass around the object B when the object B is inserted to the opening 17 based on the object data, the moving space data, and the main body data, the movement control unit 110 outputs a movement command so that at least a part of the object B is inserted to the opening 17.

The movement control unit 110 outputs a movement command based on the determination data of the first determination unit 108 and the determination data of the second determination unit 109. When the first determination unit 108 determines that the first space CP1 does not exist in the moving space RS and the second determination unit 109 determines that the second space CP2 exists in the moving space RS, the movement control unit 110 outputs a movement command so that at least a part of the object B is inserted to the opening 17.

When the first determination unit 108 determines that the first space CP1 exists in the moving space RS, the movement control unit 110 outputs a movement command so that the main body 2 moves in the first space CP1 without causing the object B to be inserted to the opening 17.

When the second determination unit 109 determines that the second space CP2 does not exist in the moving space RS, the movement control unit 110 outputs a stop command for stopping the movement of the main body 2. The movement control unit 110 outputs a stop command to the traveling motor 3.

When the main body 2 moves in the moving space RS with at least a part of the object B inserted in the opening 17, the arm control unit 111 outputs a drive command so as to move at least a part of the robot arm 7 toward the center of the trunk part 2. The arm control unit 111 outputs a drive command to the arm actuator 6.

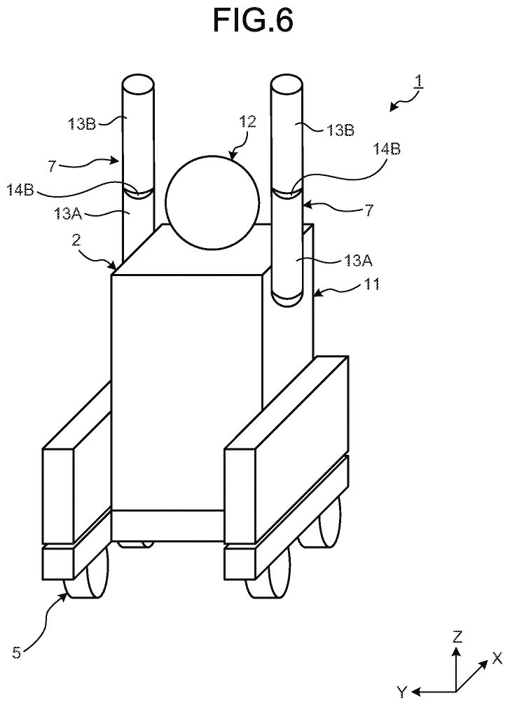

FIG. 6 is a diagram illustrating an example of operation of the robot arm 7 according to the first embodiment of the present disclosure. When the main body 2 turns around at least a part of the periphery of the object B with at least a part of the object B inserted in the opening 17, the arm control unit 111 moves at least a part of the robot arm 7 toward the center of the trunk part 11. The arm control unit 111 outputs a drive command so that, for example, each of the tip end of the robot arm 7 and the second joint 14B approaches the center of the trunk part 11 in the XY plane. The arm control unit 111 outputs a drive command so that the robot arm 7 is arranged inside the outer edge of the main body 2 in the XY plane. In the example illustrated in FIG. 6, the arm actuator 6 is driven so that the tip end of the robot arm 7 moves upward and the first link 13A and the second link 13B are parallel to each other. At least a part of the robot arm 7 moves toward the center of the trunk part 11, so that a large moment acting on the main body 2 in turning of the moving body 1 is suppressed. As a result, the moving body 1 can turn at a high speed while the falling of the moving body 1 is suppressed. The robot arm 7 is arranged inside the outer edge of the main body 2 in the XY plane, the robot arm 7 is prevented from contacting with at least one of the object B and the wall surface WP in turning of the moving body 1.

In the turning of the moving body 1, the state of the robot arm 7 is not limited to the state illustrated in FIG. 6. The tip end of the robot arm 7 may move downward, or one robot arm 7 may be brought into contact with the other robot arm 7.

### 1-3. Procedure of Method of Controlling Moving Body According to First Embodiment

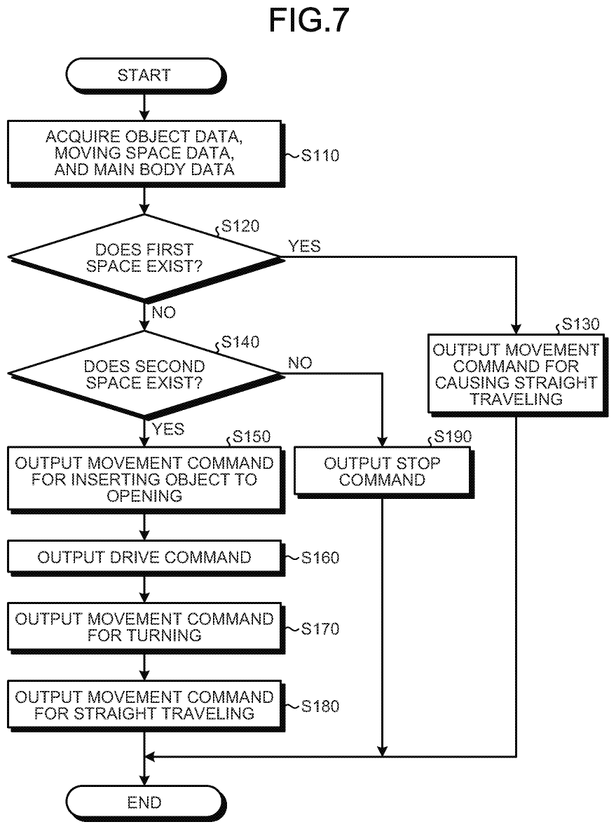

FIG. 7 is a flowchart illustrating an example of a method of controlling the moving body according to the first embodiment of the present disclosure. The movement control unit 110 outputs a movement command to the traveling motor 3 so that the traveling device 5 moves according to the target path based on the position data acquired by the position data acquisition unit 104. The traveling device 5 supports the main body 2 and travels on a moving surface TP of the moving space RS.

The object data acquisition unit 105 acquires object data from the object data storage unit 101. The moving space data acquisition unit 106 acquires moving space data from the moving space data storage unit 102. The main body data acquisition unit 107 acquires main body data from the main body data storage unit 103 (Step S110).

The first determination unit 120 determines whether the first space CP1 larger than the dimension W2 in the width direction of the main body 2 exists in the moving space RS based on the object data, the moving space data, and the main body data (Step S120).

When it is determined in Step S120 that the first space CP1 exists (Step S120: Yes), the movement control unit 110 outputs a movement command so that the main body 2 moves through the first space CP1 without causing the object B to be inserted to the opening 17. The movement control unit 110 outputs a movement command for moving the main body 2 straight in the +X direction in the first space CP1 (Step S130).

When it is determined in Step S120 that the first space CP1 does not exist (Step S120: No), the second determination unit 109 determines whether the second space CP2 through which the main body 2 can pass when at least a part of the object B is inserted to the opening 17 exists around the object B (Step S140).

When it is determined in Step S140 that the second space CP2 exists (Step S140: Yes), the movement control unit 110 outputs a movement command so that at least a part of the object B is inserted to the opening 17 (Step S150).

When a movement command for inserting the object B to the opening 17 is output, as described with reference to FIG. 4, the state of the moving body 1 transits to the first state TA1 where the moving body 1 approaches the object B in a state where the opening 17 of the main body 2 and the object B face each other. When the moving body 1 further moves in the +X direction while the opening 17 and the object B face each other, the state of the moving body 1 transitions to the second state TA2 where the object B is arranged in the insertion space 19. The object B is arranged in the insertion space 19 so as to overlap at least a part of the main body 2 in the XZ plane.

The arm control unit 111 outputs a drive command for moving at least a part of the robot arm 7 toward the center of the trunk part 11 (Step S160).

When the drive command is output, the tip end of the robot arm 7 moves upward, and the arm actuator 6 is driven so that the first link 13A and the second link 13B are parallel to each other as described with reference to FIG. 6.

The movement control unit 110 outputs a movement command so that the main body 2 turns around at least a part of the periphery of the object B in a state where the object B is arranged in the insertion space 19 (Step S170).

When a movement command for turning around at least a part of the periphery of the object B, as described with reference to FIG. 4, the state of the moving body 1 transitions in the order of the third state TA3, the fourth state TA4, and the fifth state TA5, in a state where the object B is arranged in the insertion space 19.

After the turning of the moving body 1 ends and the opening 17 faces the −X direction, the movement control unit 110 outputs a movement command for moving the moving body 1 straight in the +X direction. The state of the moving body 1 transitions to the sixth state TA6 where the moving body 1 moves in the +X direction away from the object B (Step S180).

When the moving body 1 moves in the +X direction with the opening 17 facing the −X direction, the object B arranged in the insertion space 19 is arranged outside the insertion space 19.

When it is determined in Step S140 that the second space CP2 does not exist (Step S140: No), the movement control unit 110 outputs a stop command for stopping the movement of the moving body 1 (Step S190).

When it is determined that the second space CP2 does not exist, the movement control unit 110 may move the moving body 1 in the −X direction so that the moving body 1 and the object B are separated from each other without stopping the movement of the moving body 1.

### 1-4. Effects of First Embodiment

As described above, according to the first embodiment of the present disclosure, when the object B exists in the moving space RS, the movement control unit 110 outputs a movement command so that the main body 2 moves in the moving space RS in a state where at least a part of the object B is inserted to the opening 17. As a result, even if the footprint of the traveling device 5 is large, the moving body 1 can smoothly pass through the moving space RS in which the object B exists.

The position of the object B is fixed in the moving space RS. The object B enters the insertion space 19 through the opening 17. The object B is inserted to the opening 17 so as to overlap at least a part of the main body 2 in the XZ plane orthogonal to the moving surface TP. As a result, the moving body 1 can pass through the narrow moving space RS.

The movement control unit 110 outputs a movement command so that main body 2 turns around at least a part of the periphery of the object B with at least a part of the object B inserted in the opening 17. When the main body 2 turns around at least a part of the periphery of the object B, at least a part of the main body 2 can smoothly pass between the object B and the wall surface WP even if the footprint of the traveling device 5 is large. After the turning of the moving body 1 ends, the moving body 1 travels straight so that the object B is arranged outside the insertion space 19, so that the moving body 1 can smoothly pass through the moving space RS.

When it is determined that the moving body 1 can pass around the object B when the object B is inserted to the opening 17 based on the object data, the moving space data, and the main body data, the movement control unit 110 outputs a movement command so that at least a part of the object B is inserted to the opening 17. As a result, even if the footprint of the traveling device 5 is large, the moving body 1 can smoothly pass through the moving space RS.

The first determination unit 108 determines whether the first space CP1 larger than the dimension W2 of the main body 2 in the width direction exists in the moving space RS based on the object data, the moving space data, and the main body data. The second determination unit 109 determines whether the second space CP2 through which the main body 2 can pass when at least a part of the object B is inserted to the opening 17 exists around the object S based on the object data, the moving space data, and the main body data. When the first determination unit 108 determines that the first space CP1 does not exist and the second determination unit 109 determines that the second space CP2 exists, the movement control unit 110 outputs a movement command so that at least a part of the object B is inserted to the opening 17. When the first determination unit 108 determines that the first space CP1 exists, the movement control unit 110 outputs a movement command so that the main body 2 moves in the first space CP1 without causing the object B to be inserted to the opening 17. When it is determined that the first space CP1 exists, the moving body 1 can travel straight through the first space CP1 at high speed. When the second space CP2 exists even if the first space CP1 does not exist, the moving body 1 can pass through the second space CP2 by turning around the object B.

When the second determination unit 109 determines that the second space CP2 does not exist, the movement control unit 110 outputs a stop command for stopping the movement of the main body 2. As a result, contact between the moving body 1 and at least one of the object B and the wall surface WP is suppressed.

The opening 17 is provided in the frame part 10 to which the traveling device 5 is mounted. When the object B exists at a position close to the moving surface TP in the moving space RS, the movement control unit 110 can smoothly insert the object B to the opening 17 provided in the frame part 10.

The trunk part 11 to which the robot arm 7 is coupled is provided at the front portion of the frame part 10. The opening 17 is provided at the rear portion of the frame part 10. As a result, contact between the object B inserted to the opening 17 and at least one of the trunk part 11 and the robot arm 7 is suppressed.

The dimension L11 in the front-rear direction of the trunk part 11 is smaller than a dimension W2 in the width direction of the main body 2. Even if the dimension W2 is larger than the distance WU, when the dimension L11 is smaller than the distance WU, the main body 2 can pass between the object B and the wall surface WP by the trunk part 11 turning around the object B.

The arm control unit 111 outputs a drive command for moving at least a part of the robot arm 7 toward the center of the trunk part 11 in turning of the moving body 1. As a result, as described with reference to FIG. 6, a large moment acting on the main body 2 in turning of the moving body 1 is suppressed. Therefore, the moving body 1 can turn at a high speed while the falling of the moving body 1 is suppressed. The arm actuator 6 is controlled so that the robot arm 7 does not protrude outside the outer edge of the main body 2 in the XY plane, so that the robot arm 7 is prevented from contacting at least one of the object B and the wall surface WP in turning of the moving body 1.

The wheel 4 of the traveling device 5 is an omnidirectional moving wheel. As a result, the moving body 1 can smoothly perform each of the straight-traveling operation, the turning operation, and the rotating operation.

### 2. First Modification of First Embodiment

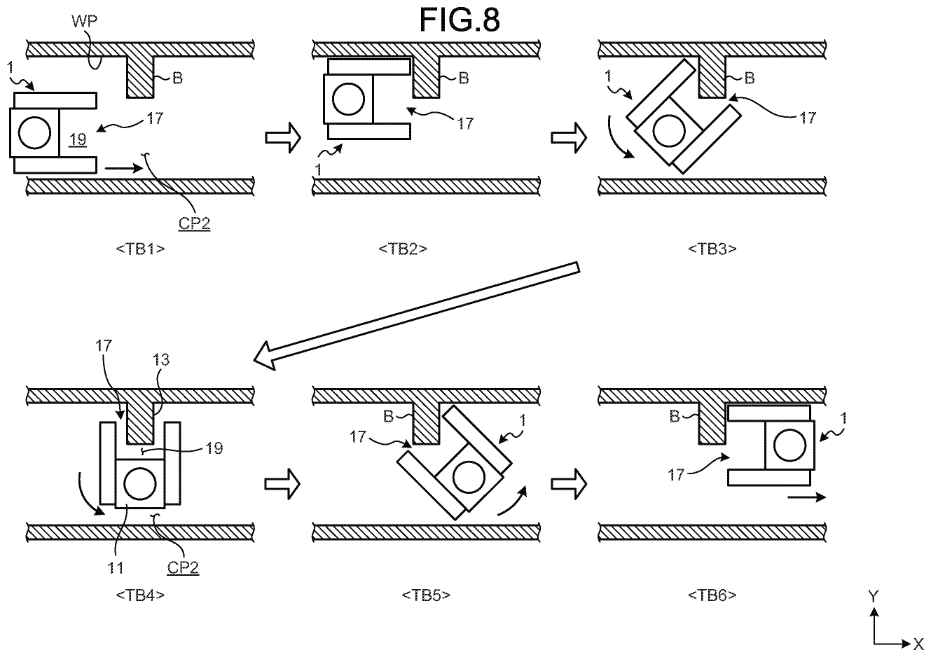

FIG. 8 is a diagram illustrating an example of operation of the moving body 1 according to a first modification of the first embodiment of the present disclosure. In the example illustrated in FIG. 8, the object B is arranged at the end portion of the moving space RS in the Y-axis direction. The object B is arranged so as to contact the wall surface WP on the +Y side. Also in the example illustrated in FIG. 8, the main body 2 turns around at least a part of the periphery of the object B in a state where at least a part of the object B is inserted to the opening 17, so that the moving body 1 can smoothly pass through the moving space RS.

When the second space CP2 exists around the object B, the state of the moving body 1 traveling straight in the moving space RS in the +X direction transitions to a first state TB1 in which the moving body 1 approaches the object B with the opening 17 of the main body 2 and the object B facing each other.

The moving body 1 moves in the +Y direction so as to approach the object B with the opening 17 and the object B facing each other, so that the state of the moving body 1 transitions to a second state TB2 immediately before the object B is inserted to the opening 17.

After approaching the object B, the state of the moving body 1 transitions in the order of a third state TB3, a fourth state TB4, and a fifth state TB5 where the moving body 1 turns around at least a part of the periphery of the object B.

The third state TB3 is a state immediately after the moving body 1 starts turning, and indicates a state where at least a part of the object B is inserted to the opening 17. The fourth state TB4 indicates a state where the object B is arranged in the insertion space 19 and the trunk part 11 is arranged in the second space CP2 by the turning of the moving body 1. The fifth state TB5 indicates the state immediately before the end of the turning of the moving body 1. The moving body 1 turns around at least a part of the periphery of the object B until the opening 17 faces the −X direction.

After the turning ends, the state of the moving body 1 transitions to a sixth state TB6 where the moving body 1 moves in the +X direction away from the object B. The moving body 1 moves in the +X direction with the opening 17 facing the −X direction, so that the object B is arranged outside the insertion space 19.

As described above, also in the first modification of the first embodiment of the present disclosure, the moving body 1 can smoothly pass through the moving space RS in which the object B exists.

### 3. Second Modification of First Embodiment

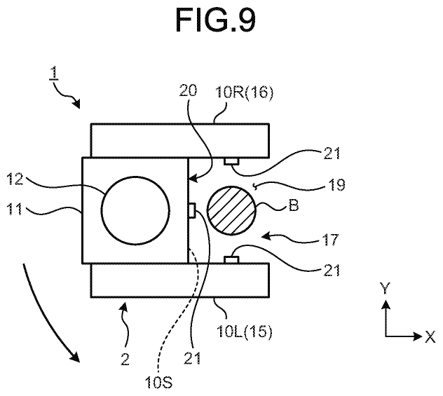

FIG. 9 is a diagram illustrating an example of operation of the moving body 1 according to a second modification of the first embodiment of the present disclosure. As illustrated in FIG. 9, the movement control unit 110 can output a movement command so that the main body 2 moves in a state where the object B inserted to the insertion space 19 and the inner surface 20 of the main body 2 defining the insertion space 19 are separated from each other. The inner surface 20 of the main body 2 includes the right surface of the left frame 10L, the left surface of the right frame 10R, the rear surface of the support frame 10S, the right surface of the battery housing 15, the left surface of the control housing 16, and the rear surface of the trunk part 11.

In the example illustrated in FIG. 9, the moving body 1 includes a distance sensor 21 that detects the distance between the inner surface 20 and the surface of the object B. The distance sensor 21 is provided on the inner surface 20. A plurality of distance sensors 21 are provided so as to surround the object B arranged in the insertion space 19. The movement control unit 110 outputs a movement command based on the detection data of the distance sensor 21 so that the gap between the inner surface 20 and the surface of the object B is maintained. The moving body 1 turns around at least a part of the periphery of the object B in a state where the gap between the inner surface 20 and the surface of the object B is maintained.

Damage to the object B and the main body 2 is suppressed by turning of the main body 2 in a state where the surface of the object B inserted to the insertion space 19 and the inner surface 20 of the main body 2 are separated from each other.

### 4. Third Modification of First Embodiment

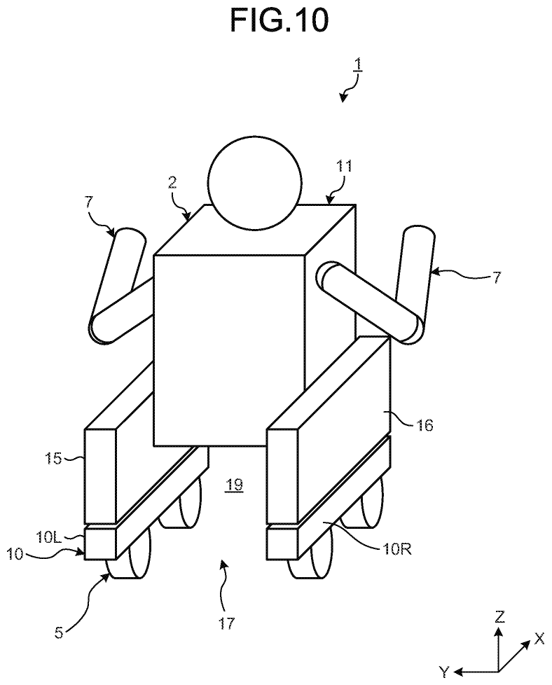

FIG. 10 is a diagram illustrating an example of the moving body 1 according to a third modification of the first embodiment of the present disclosure. The frame part 10 has the left frame 10L and the right frame 10R. In the example illustrated in FIG. 10, the support frame 10S does not exist. The trunk part 11 is supported by the left frame 10L and the right frame 10R. The trunk part 11 may be connected to the battery housing 15 and the control housing 16. The insertion space 19 is formed below the trunk part 11 so as to connect the space in front of the moving body 1 and the space in rear of the moving body 1.

The insertion space 19 is formed so as to connect the space in front of the moving body 1 and the space in rear of the moving body 1, so that, in the example illustrated in FIG. 10, even if the object B is long in the X-axis direction, the object B is smoothly inserted to the insertion space 19.

### 5. Fourth Modification of First Embodiment

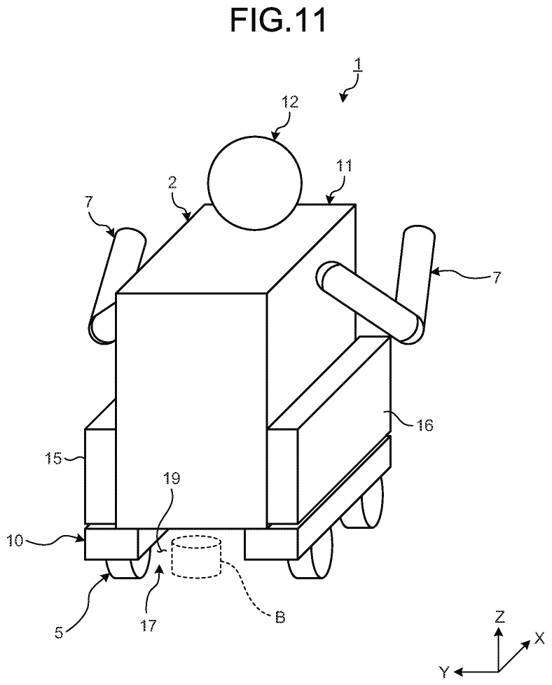

FIG. 11 is a diagram illustrating an example of the moving body 1 according to a fourth modification of the first embodiment of the present disclosure. In the example illustrated in FIG. 11, the dimension of the trunk part 11 in the front-rear direction and the dimension of the frame part 10 in the front-rear direction are substantially equal to each other. The opening 17 is provided on the rear end surface of the frame part 10. At least a part of the trunk part 11 is arranged above the insertion space 19.

When the object B is provided so as to project in the +Z direction from the moving surface TP and the dimension of the object B in the Z-axis direction is small, the object B can enter the insertion space 19 through the opening 17. The object B is inserted to the opening 17 so as to overlap at least a part of the main body 2 in both the XY plane parallel to the moving surface TP and the XZ plane orthogonal to the moving surface TP. Also in the example illustrated in FIG. 11, the moving body 1 can smoothly pass through the moving space RS in which the object B exists.

### 6. Fifth Modification of First Embodiment

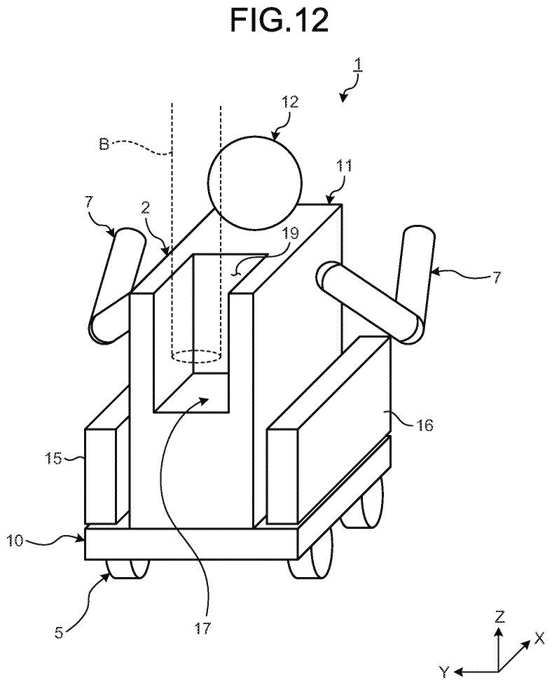

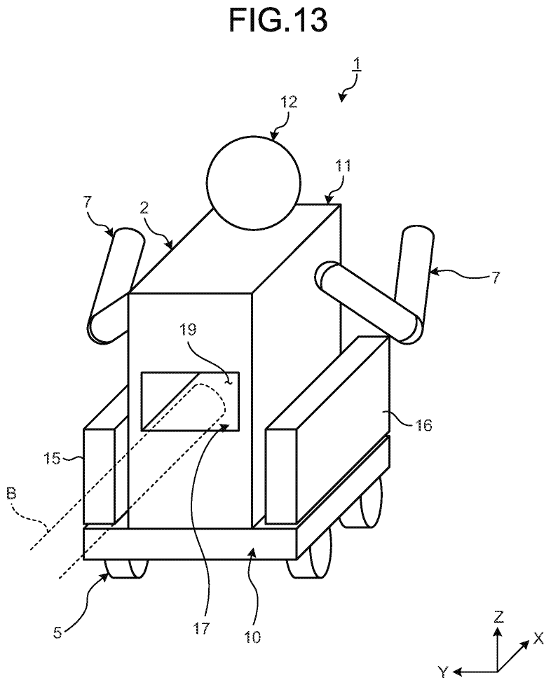

FIG. 12 is a diagram illustrating an example of the moving body 1 according to a fifth modification of the first embodiment of the present disclosure. As illustrated in FIG. 12, the opening 17 to which the object B is inserted may be provided in the trunk part 11. In the example illustrated in FIG. 12, the openings 17 are provided in the upper part of the rear end surface and the rear portion of the upper end surface of the trunk part 11.

When the object B is provided so as to project in the −Z direction from the ceiling surface of the moving space RS, the opening 17 is provided in the upper part of the trunk part 11, so that the object B can enter the insertion space 19 through the opening 17. The object B is inserted to the opening 17 so as to overlap at least a part of the main body 2 in both the XY plane and the XZ plane. Also in the example illustrated in FIG. 12, the moving body 1 can smoothly pass through the moving space RS in which the object B exists.

### 7. Sixth Modification of First Embodiment

FIG. 13 is a diagram illustrating an example of the moving body 1 according to a sixth modification of the first embodiment of the present disclosure. As illustrated in FIG. 13, the opening 17 may be provided in the central portion of the rear end surface of the trunk part 11.

When the object B is provided so as to project from the wall surface WP of the moving space RS, the opening 17 is provided at the central portion of the trunk part 11 in the Z-axis direction, so that the object B can enter the insertion space 19 through the opening 17. The object B is inserted to the opening 17 so as to overlap at least a part of the main body 2 in both the XY plane and the XZ plane. Also in the example illustrated in FIG. 13, the moving body 1 can smoothly pass through the moving space RS in which the object B exists.

### 8. Seventh Modification of First Embodiment

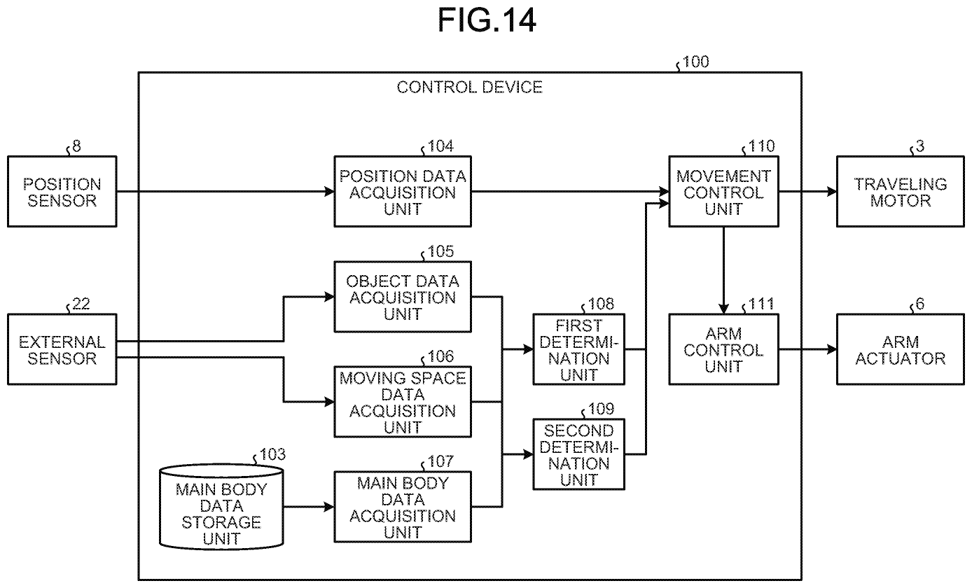

FIG. 14 is a functional block diagram illustrating an example of the control device 100 according to a seventh modification of the first embodiment of the present disclosure. In the above-described embodiment, the object data is stored in the object data storage unit 101 in advance, and the moving space data is stored in the moving space data storage unit 102 in advance. As illustrated in FIG. 14, the moving body 1 may include an external sensor 22 capable of acquiring the object data and the moving space data. As the external sensor 22, a camera sensor capable of acquiring image data of the object B and the moving space RS is exemplified. When the external sensor 22 is a camera sensor, the image data of the moving space RS and the image data of the object B existing in the moving space RS are acquired by the camera sensor before the moving body 1 moves in the moving space RS. The object data acquisition unit 105 can perform image processing on the image data of the object B to acquire the object data including at least one of the position, the dimension, and the outer shape of the object B existing in the moving space RS. The moving space data acquisition unit 106 can perform image processing on the image data of the moving space RS to acquire the moving space data including at least one of the dimension of the moving space RS and the shape of the wall surface WP. As the external sensor 22, a laser scanner capable of acquiring three-dimensional data of the object B and the moving space RS may be used. As the external sensor 22, at least one of a Time of Flight (ToF), a force sensor, a contact sensor, a pressure sensor, a tactile sensor, a distance measuring sensor, an electrostatic sensor, and a magnetic sensor may be used.

### 9. Second Embodiment

### 9-1. Configuration of Moving Body According to Second Embodiment

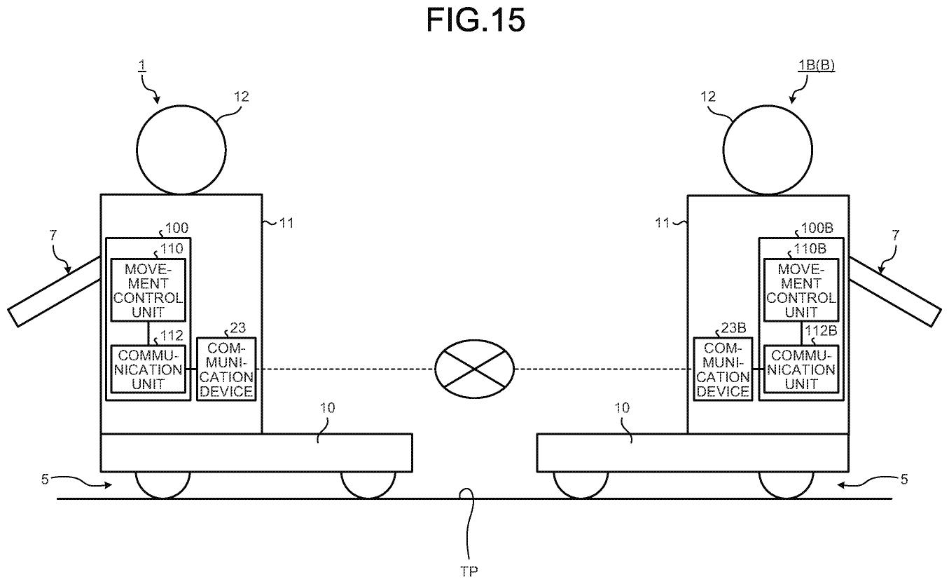

Next, a second embodiment will be described. FIG. 15 is a diagram illustrating an example of the moving body 1 and the object B according to the second embodiment of the present disclosure. The object B can move in the moving space RS. In the second embodiment of the present disclosure, the object B is a moving body 1B different from the moving body 1. The moving body 1B can move the moving surface TP. In the description below, the moving body 1B is appropriately referred to as an external moving body 1B.

The structure of moving body 1 and the structure of the external moving body 1B are equal. The function of moving body 1 and the function of the external moving body 1B are equal.

The control device 100 according to the second embodiment of the present disclosure includes a communication unit 112 in addition to the components of the control device 100 according to the first embodiment. In FIG. 15, of the plurality of components of the control device 100, only the movement control unit 110 and the communication unit 112 are described, and the description of the other components is omitted. The moving body 1 according to the second embodiment of the present disclosure includes a communication device 23.

The external moving body 1B includes a control device 100B. The control device 100B has the same components as those of the control device 100. In FIG. 15, of the plurality of components of the control device 100B, only a movement control unit 110B and a communication unit 112B are described, and the description of the other components is omitted. The external moving body 1B includes a communication device 23B. The communication device 23 of the moving body 1 communicates with the communication device 23B of the external moving body 1B. The communication device 23 communicates with the communication device 23B via the wireless local area network.

The moving body 1 and the external moving body 1B may perform short-range wireless communication, infrared communication, or voice communication.

The movement control unit 110 outputs a movement command so that the main body 2 rotates about a rotation axis AX orthogonal to the moving surface TP in a state where at least a part of the external moving body 1B is inserted to the opening 17 of the moving body 1.

The movement control unit 110 outputs a movement command so that the main body 2 moves in synchronization with the external moving body 1B in a state where at least a part of the external moving body 1B is inserted to the opening 17 of the moving body 1. The movement control unit 110 outputs a movement command so that the main body 2 moves in synchronization with the external moving body 1B based on the communication data with the external moving body 1B.

When the moving body 1 rotates about the rotation axis AX, the arm control unit 111 outputs a drive command for moving at least a part of the robot arm 7 toward the center of the trunk part 11 as described with reference to FIG. 6.

### 9-2. Procedure of Method of Controlling Moving Body According to Second Embodiment

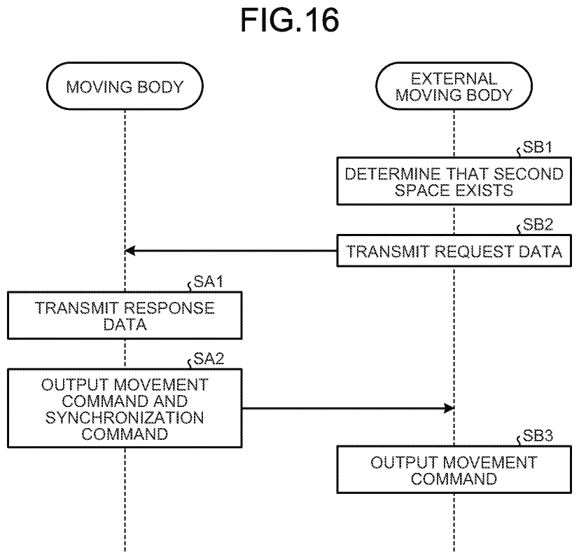

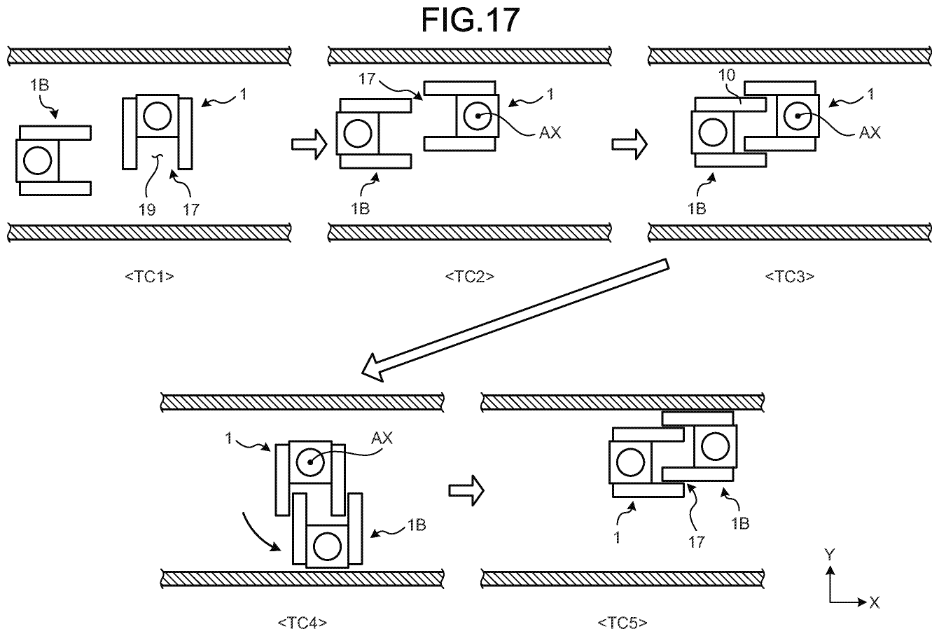

FIG. 16 is a flowchart illustrating an example of a method of controlling the moving body 1 according to the second embodiment of the present disclosure. FIG. 17 is a diagram illustrating an example of operation of the moving body 1 according to the second embodiment of the present disclosure.

For example, when the moving body 1 moves in the moving space RS in the −X direction and the external moving body 1B moves in the moving space RS in the +X direction, if the width of the moving space RS is small, there is a possibility that the moving body 1 in a straight-traveling state and the external moving body 1B in the straight-traveling state cannot pass each other.

When the external moving body 1B is provided with the external sensor 22, the control device 100B of the external moving body 1B determines whether the second space CP2 exists around the moving body 1 based on the detection data of the external sensor 22. When it is determined that the second space CP2 exists around the moving body 1 (Step SB1), the control device 100B outputs request data for requesting that at least a part of the external moving body 1B is inserted to the opening 17 of the moving body 1. The request data is transmitted to the moving body 1 via the communication device 23B (Step SB2).

After acquiring the request data, the control device 100 of the moving body 1 outputs response data that allows at least a part of the external moving body 1B to be inserted to the opening 17 of the moving body 1. The response data is transmitted to the external moving body 1B via the communication device 23 (Step SA1).

After receiving the response data, the state of the external moving body 1B traveling straight in the moving space RS in the +X direction transitions to a first state TC1 where the external moving body 1B approaches the moving body 1.

After the moving body 1 and the external moving body 1B approach each other, the state of the moving body 1 transitions to a second state TC2 where the opening 17 faces the external moving body 1B. The moving body 1 rotates about the rotation axis AX orthogonal to the moving surface TP so that the opening 17 faces the −X direction. The moving body 1 rotates, so that the external moving body 1B moving in the +X direction and the opening 17 of the moving body 1 face each other.

After the opening 17 and the external moving body 1B face each other, the state transitions to a third state TC3 where at least a part of the frame part 10 of the external moving body 1B is inserted to the opening 17. The external moving body 1B can move toward the opening 17 in the +X direction to cause at least a part of the frame part 10 to be inserted to the opening 17.

After at least a part of the external moving body 1B is inserted to the opening 17, the movement control unit 110 of the moving body 1 outputs a movement command to the traveling motor 3 of the moving body 1 so that the moving body 1 and the external moving body 1B move in synchronization with each other, with at least a part of the external moving body 1B inserted to the opening 17. The communication unit 112 of the moving body 1 outputs a synchronization command so that the moving body 1 and the external moving body 1B move in synchronization with each other. The synchronization command is transmitted to the external moving body 1B via the communication device 23 (Step SA2).

The movement control unit 110B of the external moving body 1B outputs a movement command to the traveling motor 3 of the external moving body 1B so that the moving body 1 and the external moving body 1B move in synchronization with each other, based on the synchronization command transmitted from the moving body 1 (Step SB3).

In the present disclosure, the movement control unit 110 of the moving body 1 outputs a movement command so that the main body 2 rotates about the rotation axis AX orthogonal to the moving surface TP in a state where at least a part of the external moving body 1B is inserted to the opening 17. Based on the synchronization command, the movement control unit 110B of the external moving body 1B outputs a movement command so that the external moving body 1B turns around at least a part of the periphery of the moving body 1 in synchronization with the rotation of the moving body 1.

When the movement command and the synchronization command are output, the state transitions to a fourth state TC4 where the moving body 1 rotates about the rotation axis AX and the external moving body 1B turns around at least a part of the periphery of the moving body 1. The moving body 1 rotates in synchronization with the turning of the external moving body 1B.

The moving body 1 rotates until the opening 17 faces the +X direction. After the rotation of the moving body 1 ends and the turning of the external moving body 1B ends, the state transitions to a fifth state TC5 where the external moving body 1B moves in the +X direction so as to move away from the moving body 1. The moving body 1 separated from the external moving body 1B moves in the −X direction. The external moving body 1B separated from the moving body 1 moves in the +X direction.

The moving body 1 may perform the processing of Steps SB1, SB2, and SB3, and the external moving body 1B may perform the processing of Steps SA1 and SA2. For example, the movement control unit 110 of the moving body 1 may output a movement command so that the moving body 1 rotates in synchronization with the turning of the external moving body 1B based on the synchronization command transmitted from the external moving body 1B.

### 9-3. Effect of Second Embodiment

As described above, according to the second embodiment of the present disclosure, even when the width of the moving space RS is small and the moving body 1 in the straight-traveling state and the external moving body 1B in the straight-traveling state cannot pass each other, at least a part of the external moving body 1B is inserted to the opening 17 of the moving body 1, so that each of the moving body 1 and the external moving body 1B can pass through the moving space RS.

The movement control unit 110 outputs a movement command so that the moving body 1 rotates about the rotation axis AX orthogonal to the moving surface TP in a state where at least a part of the external moving body 1B is inserted to the opening 17 of the moving body 1. The moving body 1 rotates about the rotation axis AX, and the external moving body 1B turns around at least a part of the periphery of the moving body 1, so that each of the moving body 1 and the external moving body 1B can smoothly pass through the moving space RS.

The movement control unit 110 outputs a movement command so that the moving body 1 and the external moving body 1B move in synchronization with each other. As a result, each of the moving body 1 and the external moving body 1B can smoothly pass through the moving space RS.

The movement control unit 110 outputs a movement command so that the moving body 1 and the external moving body 1B move in synchronization with each other based on the communication data with the external moving body 1B. As a result, the moving body 1 can move at an appropriate timing while recognizing the situation of the external moving body 1B.

When the area occupied by the moving body 1 defined by the virtual line connecting the outer edges of the moving body 1 in the XY plane is Ar1, the area of the object B defined by the virtual line connecting the outer edges of the external moving body 1B in the XY plane is Ar2, and the total area defined by the virtual line connecting the outer edges of the moving body 1 and the external moving body 1B in the XY plane in a state where at least a part of the external moving body 1B is arranged in the insertion space 19 is Ar3, in the present disclosure, the insertion space 19 is defined so as to satisfy the condition [(Ar1+Ar2)×0.8 Ar3]. As a result, the occupied area of the moving body 1 and the external moving body 1B becomes sufficiently small in a state where at least a part of the external moving body 1B is arranged in the insertion space 19. Therefore, the moving body 1 and the external moving body 1B can smoothly move in the moving space RS even if the width of the moving space RS is small.

### 10. First Modification of Second Embodiment

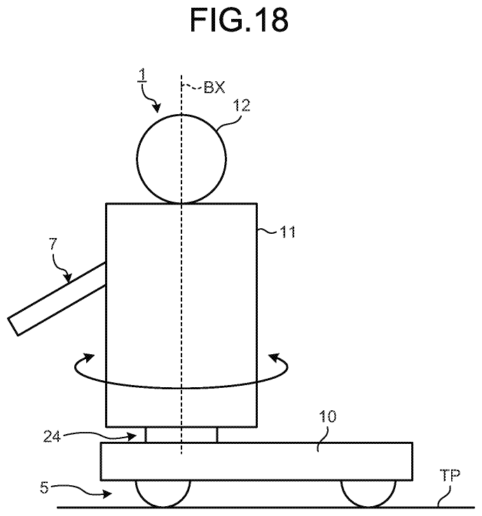

FIG. 18 is a diagram illustrating an example of the moving body 1 according to a first modification of the second embodiment of the present disclosure. As illustrated in FIG. 18, the moving body 1 includes a rotating device 24 that rotatably couples the trunk part 11 and the frame part 10. The trunk part 11 is rotatably supported by the frame part 10 via the rotating device 24. The rotating device 24 includes a rotating motor and a bearing. The trunk part 11 and the frame part 10 rotate relative to each other about a rotation axis BX orthogonal to the moving surface TP.

The movement control unit 110 outputs a movement command to each of the traveling motor 3 and the rotating device 24 so that the trunk part 11 and the frame part 10 rotate relative to each other in a state where at least a part of the external moving body 1B is inserted to the opening 17 of the moving body 1. The movement control unit 110 can output a movement command so that the frame part 10 rotates about the rotation axis BX while maintaining a state where the front surface of the trunk part 11 faces the +Y direction, for example.

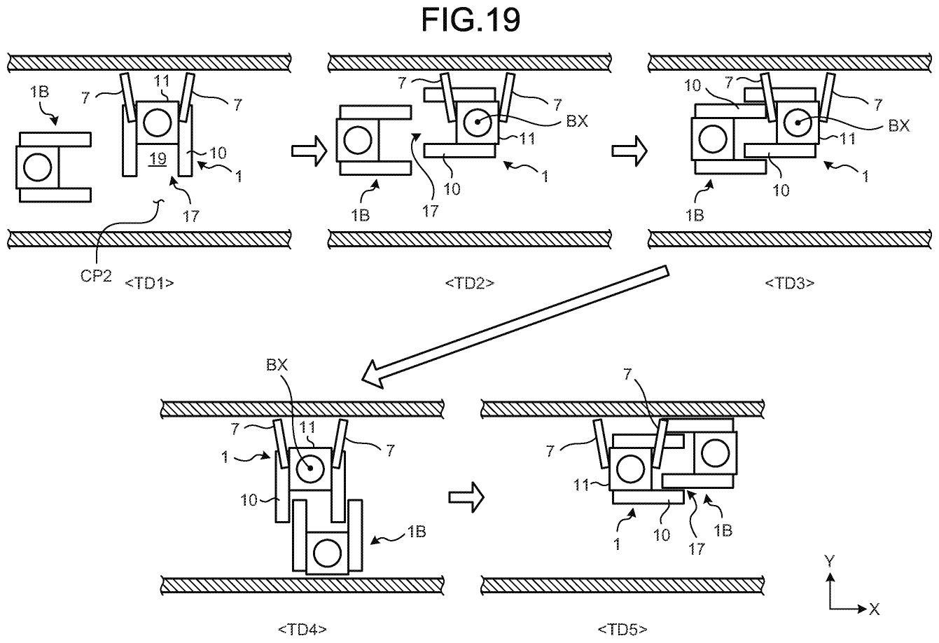

FIG. 19 is a diagram illustrating an example of operation of the moving body 1 according to the first modification of the second embodiment of the present disclosure.

When the moving body 1 is performing work using the robot arm 7 in a part of the moving space RS, the external moving body 1B may move in the moving space RS in the +X direction. In the example illustrated in FIG. 19, the traveling motor 3 of the moving body 1 is not driven, and the moving body 1 performs the work in a state of being stopped in a part of the moving space RS. For example, when the robot arm 7 is performing work on a work target existing in the +Y direction with respect to the moving body 1, the state where the front surface of the trunk part 11 faces the +Y direction is maintained. If the width of the moving space RS on the rear surface side of the trunk part 11 is small, the external moving body 1B may not be able to travel straight around the moving body 1.

When it is determined that the second space CP2 exists around the moving body 1, the external moving body 1B outputs request data for requesting that at least a part of the external moving body 1B is inserted to the opening 17 of the moving body 1. After acquiring the request data, the control device 100 of the moving body 1 outputs response data that allows at least a part of the external moving body 1B to be inserted to the opening 17 of the moving body 1. After receiving the response data, the state of the external moving body 1B traveling straight in the moving space RS in the +X direction transitions to a first state TD1 where the external moving body 1B approaches the moving body 1.

After the moving body 1 and the external moving body 1B approach each other, the state of the moving body 1 transitions to a second state TD2 where the opening 17 faces the external moving body 1B. The movement control unit 110 outputs a movement command so that the opening 17 faces the −X direction while maintaining the state where the front surface of the trunk part 11 faces the +Y direction. That is, the movement control unit 110 rotates only the frame part 10 in the θZ direction while maintaining the position of the trunk part 11 in the θZ direction. The frame part 10 rotates, so that the external moving body 1B moving in the +X direction and the opening 17 of the frame part 10 face each other. Since the position of the trunk part 11 in the θZ direction does not change, the moving body 1 can continue the work by the robot arm 7.

After the opening 17 and the external moving body 1B face each other, the state transitions to a third state TD3 where at least a part of the frame part 10 of the external moving body 1B is inserted to the opening 17. The external moving body 1B can move toward the opening 17 in the +X direction to cause at least a part of the frame part 10 of the external moving body 1B to be inserted to the opening 17.

After at least a part of the external moving body 1B is inserted to the opening 17, the movement control unit 110 of the moving body 1 outputs a movement command to the traveling motor 3 and the rotating device 24 of the moving body 1 so that the frame part 10 of the moving body 1 and the external moving body 1B move in synchronization with each other, with at least a part of the external moving body 1B inserted to the opening 17.

The movement control unit 110 of the moving body 1 outputs a movement command so that the frame part 10 of the moving body 1 rotates about the rotation axis BX orthogonal to the moving surface TP in a state where at least a part of the external moving body 1B is inserted to the opening 17. The movement control unit 110B of the external moving body 1B outputs a movement command to the traveling motor 3 of the external moving body 1B so that the external moving body 1B turns around at least a part of the periphery of the trunk part 11 of the moving body 1 in synchronization with the rotation of the frame part 10. As a result, the state transitions to a fourth state TD4 where the frame part 10 of the moving body 1 rotates about the rotation axis BX and the external moving body 1B turns around at least a part of the periphery of the trunk part 11 of the moving body 1. The frame part 10 of the moving body 1 rotates in synchronization with the turning of the external moving body 1B. Even if the frame part 10 of the moving body 1 rotates, since the position of the trunk part 11 of the moving body 1 in the θZ direction does not change, the moving body 1 can continue the work by the robot arm 7.

The frame part 10 of the moving body 1 rotates until the opening 17 faces the +X direction. After the rotation of the frame part 10 of the moving body 1 ends and the turning of the external moving body 1B ends, the state transitions to a fifth state TD5 where the external moving body 1B moves in the +X direction so as to move away from the object B. The external moving body 1B separated from the moving body 1 moves in the +X direction. The moving body 1 continues the work by the robot arm 7 with the front surface of the trunk part 11 facing the +Y direction.

As described above, in the moving body 1, the trunk part 11 to which the robot arm 7 is coupled and the frame part 10 to which the traveling device 5 is mounted rotate relative to each other, so that the external moving body 1B can pass around the moving body 1 in a state where the work by the robot arm 7 of the moving body 1 is continued.

### 11. Second Modification of Second Embodiment

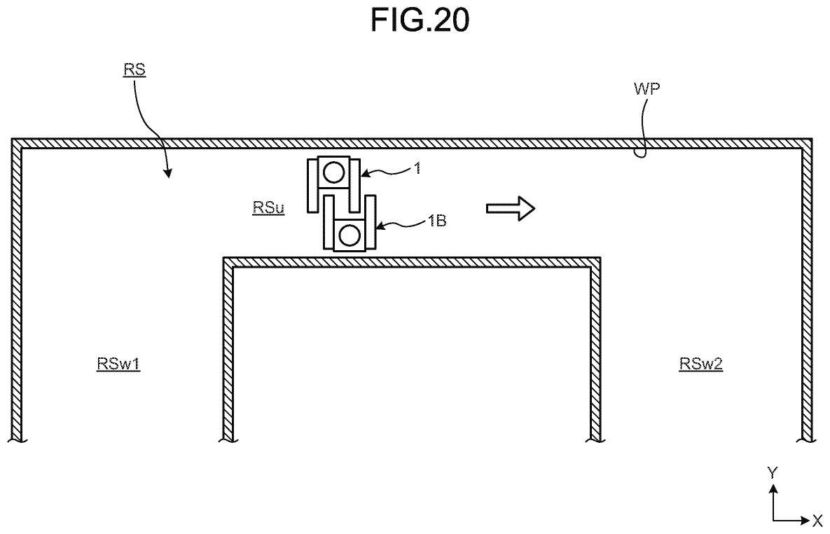

FIG. 20 is a diagram illustrating an example of operation of the moving body 1 according to a second modification of the second embodiment of the present disclosure. As illustrated in FIG. 20, the moving body 1 may travel straight in the X-axis direction in synchronization with the external moving body 1B in a state where at least a part of the external moving body 1B is inserted to the opening 17. When the moving space RS includes a first moving space RSn having a small width and a second moving space RSw1 and a third moving space RSw2 each having a large width, the moving body 1 and the external moving body 1B may be translated in the first moving space RSn in the X-axis direction in a state where at least a part of the external moving body 1B is inserted to the opening 17. In the second moving space RSw1 and the third moving space RSw2, the moving body 1 and the external moving body 1B can pass each other.

For example, when the external moving body 1B moves from the second moving space RWs1 to the third moving space RSw2 via the first moving space RSn, the operation of inserting at least a part of the external moving body 1B to the opening 17 of the moving body 1 is performed in the second moving space RSw1. After at least a part of the external moving body 1B is inserted to the opening 17 of the moving body 1 in the second moving space RSw1, the moving body 1 and the external moving body 1B translate in the first moving space RSn in the +X direction. When the moving body 1 and the external moving body 1B move to the third moving space RSw2, the external moving body 1B moves away from the moving body 1. As a result, the external moving body 1B can move from the second moving space RWs1 to the third moving space RSw2 via the first moving space RSn.

### 12. Third Modification of Second Embodiment

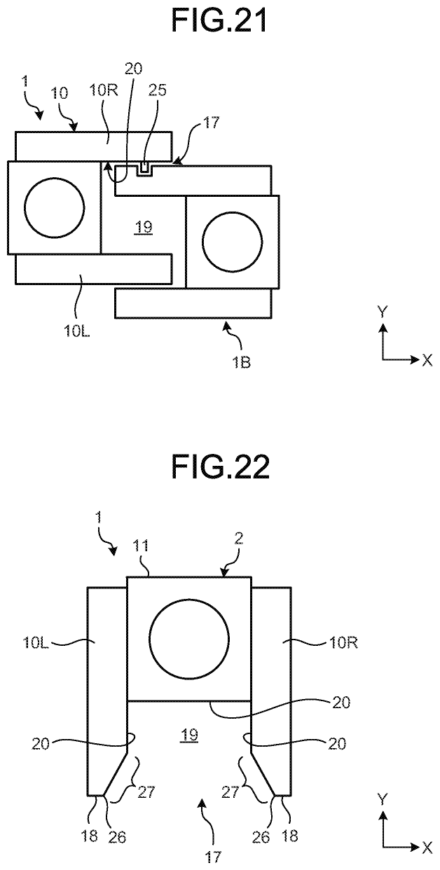

FIG. 21 is a diagram illustrating an example of the moving body 1 and the external moving body 1B according to a third modification of the second embodiment of the present disclosure. As illustrated in FIG. 21, the moving body 1 has a coupling member 25 provided in the insertion space 19 and to which the external moving body 1B is coupled. The coupling member 25 includes a projection member projecting from the inner surface 20 that defines the insertion space 19. In the example illustrated in FIG. 21, the coupling member 25 projects from the left surface of the right frame 10R toward the center of the insertion space 19. The external moving body 1B is provided with a hole into which the coupling member 25 is fitted.

The coupling member 25 is provided, so that the moving body 1 and the external moving body 1B can move in synchronization with each other in a coupled state. The moving body 1 and the external moving body 1B can move in synchronization with each other in a state where the relative positions are sufficiently maintained.

### 13. Other Embodiments

The processing according to each of the above-described embodiments may be carried out in various different forms other than each of the above-described embodiments.

FIG. 22 is a diagram illustrating an example of the moving body 1 according to another embodiment of the present disclosure. The main body 2 has an outer surface 18 arranged at least a part of the periphery of the opening 17 and an inner surface 20 defining the insertion space 19 in which the object B inserted to the opening 17 is arranged. A boundary 26 between the outer surface 18 and the inner surface 20 defines the opening 17. A part of a region 27 of the inner surface 20 including the boundary 26 is inclined toward the opening 17 so as to be away from the center of the opening 17. In the cross section parallel to the XY plane, the region 27 of the left frame 10L is inclined to the left toward the rear. In the cross section parallel to the XY plane, the region 27 of the right frame 10R is inclined to the right toward the rear. In the cross section parallel to the XY plane, the region 27 of the left frame 10L and the region 27 of the right frame 10R gradually separate toward the opening 17. That is, the region 27 is tapered. In a cross section parallel to the XY plane, the region 27 may be a straight line or a curved line. Since the region 27 including the boundary 26 defining the opening 17 is tapered, the object B is smoothly inserted to the insertion space 19 through the opening 17 while being guided by the region 27.

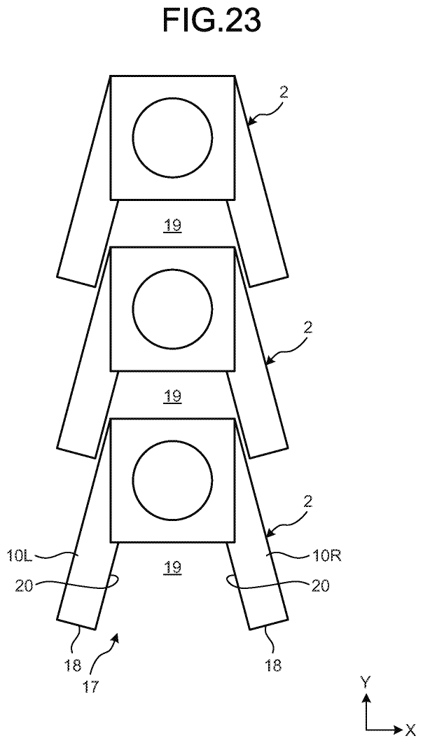

FIG. 23 is a diagram illustrating an example of the moving body 1 according to another embodiment of the present disclosure. The main body 2 has an insertion space 19 in which the object B inserted in the opening 17 is arranged. In a cross section parallel to the XY plane, the insertion space 19 extends towards the opening 17. As illustrated in FIG. 23, since the inner surface 20 is inclined toward the opening 17, when a plurality of moving bodies 1 are stored side by side, the trunk part 11 of the second moving body 1 can be arranged in the insertion space 19 of the first moving body 1. Therefore, the storage space can be reduced.

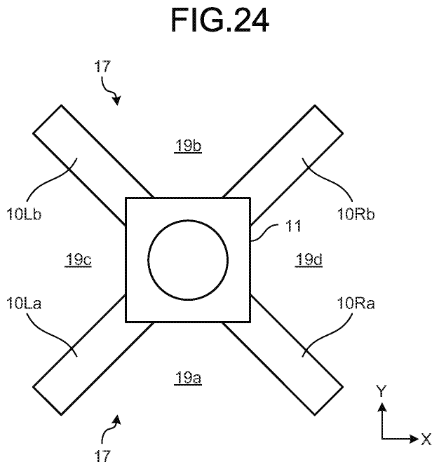

FIG. 24 is a diagram illustrating an example of the moving body 1 according to another embodiment of the present disclosure. The frame part 10 includes a first left frame 10La, a first right frame 10Ra, a second left frame 10Lb, and a second right frame 10Rb. The first left frame 10La and the first right frame 10Ra are arranged on the −Y side of the trunk part 11. The second left frame 10Lb and the second right frame 10Rb are arranged on the +Y side of the trunk part 11. The first left frame 10La and the first right frame 10Ra define a first insertion space 19a. The second left frame 10Lb and the second right frame 10Rb define a second insertion space 19b. The first insertion space 19a expands in the −Y direction. The second insertion space 19b expands in the +Y direction. A third insertion space 19c is defined between the first left frame 10La and the second left frame 10Lb. A fourth insertion space 19d is defined between the first right frame 10Ra and the second right frame 10Rb. As described above, a plurality of insertion spaces 19 may be provided around the trunk part 11.

When the moving body 1 turns or rotates, light or sound may be output from the moving body 1.

The object B that moves in synchronization with the moving body 1 in the moving space RS does not have to be the external moving body 1B. The object B that moves in synchronization with the moving body 1 may be an object having a structure or function different from that of the moving body 1.

If the robot arm 7 holds an article, the article may be placed in a designated storage space before the moving body 1 turns or rotates. If the moving body 1 turns or rotates while the robot arm 7 holds an article, the article may fall or the turning or rotation of the moving body 1 may become unstable. A movement command for turning or rotating the moving body 1 without the robot arm 7 holding the article is output, so that the moving body 1 can smoothly turn or rotate.

The moving body 1 may be any mobile robot capable of traveling on the moving surface TP, and may be at least one of a guidance robot, a kitchen robot, a nursing robot, and a domestic robot.

The moving body 1 does not have to have the robot arm 7. The moving body 1 may be, for example, a robot dust collector.

The moving body 1 does not have to have the traveling device 5. The moving body 1 may fly in the moving space RS. The moving body 1 may be an unmanned aerial vehicle (UAV) such as a drone. The movement control unit 110 may perform control so that the main body 2 flies in the moving space RS in a state where at least a part of the object existing in the moving space RS is inserted to the opening 17 of the moving body 1.

Among the processes described in each of the above embodiments, all or part of the processes described as being automatically performed can be manually performed, or all or part of the processes described as being manually performed can be automatically performed by a known method. The processing procedure, specific name, and information including various data and parameters shown in the above document and drawings can be arbitrarily changed unless otherwise specified. For example, the various types of information illustrated in each drawing is not limited to the illustrated information.

Each component of each of the illustrated devices is a functional concept, and does not necessarily have to be physically configured as illustrated in the drawings. That is, the specific form of distribution/integration of each device is not limited to the one illustrated in the drawing, and all or part of the device can be configured by being functionally or physically distributed/integrated in arbitrary units according to various loads and usage conditions. For example, the object data acquisition unit 105, the moving space data acquisition unit 106, and the main body data acquisition unit 107 illustrated in FIG. 5 may be integrated, or the first determination unit 108 and the second determination unit 109 may be integrated.

The above-described embodiments and modifications can be appropriately combined as long as the processing contents do not contradict each other.

The effects described in the present specification are merely examples and are not limited, and there may be other effects.

### 14. Hardware Configuration

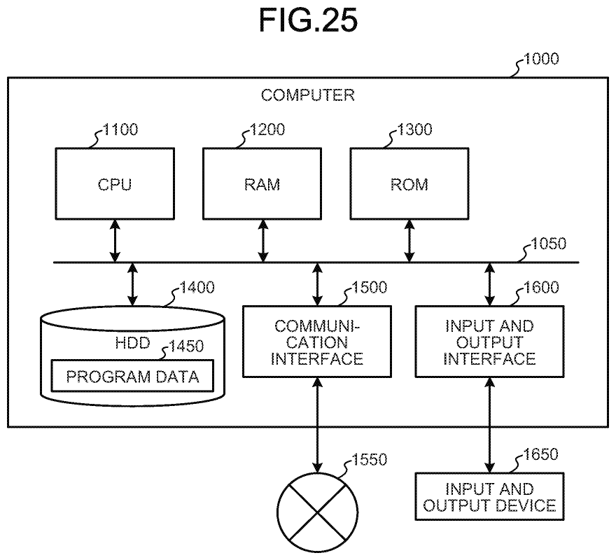

The control device 100 according to each of the above-described embodiments is achieved by, for example, a computer 1000 having a configuration as illustrated in FIG. 25. Hereinafter, the control device 100 according to the first embodiment will be described as an example. FIG. 25 is a hardware configuration diagram illustrating an example of the computer 1000 that achieves functions of the control device 100. The computer 1000 has a CPU 1100, a RAM 1200, a read only memory (ROM) 1300, a hard disk drive (HDD) 1400, a communication interface 1500, and an input and output interface 1600. Each part of the computer 1000 is connected by a bus 1050.

The CPU 1100 operates based on the program stored in the ROM 1300 or the HDD 1400, and controls each part. For example, the CPU 1100 loads the program stored in the ROM 1300 or the HDD 1400 into the RAM 1200 and executes processing corresponding to various programs.

The ROM 1300 stores a boot program such as a basic input output system (BIOS) executed by the CPU 1100 when the computer 1000 is started, a program that depends on the hardware of the computer 1000, and the like.

The HDD 1400 is a computer-readable recording medium that non-temporarily records a program executed by the CPU 1100 and data used by the program. Specifically, the HDD 1400 is a recording medium for recording an image processing program according to the present disclosure, which is an example of program data 1450.

The communication interface 1500 is an interface for the computer 1000 to connect to an external network 1550 (for example, the Internet). For example, the CPU 1100 receives data from another device or transmits data generated by the CPU 1100 to another device via the communication interface 1500.

The input and output interface 1600 is an interface for connecting an input and output device 1650 and the computer 1000. For example, the CPU 1100 receives data from an input device such as a keyboard or mouse via the input and output interface 1600. The CPU 1100 also transmits data to output devices such as a display, a speaker, and a printer via the input and output interface 1600. The input and output interface 1600 may function as a media interface for reading a program or the like recorded on a predetermined recording medium. The medium is, for example, an optical recording medium such as a digital versatile disc (DVD) or a phase change rewritable disk (PD), a magneto-optical recording medium such as a magneto-optical disk (MO), a tape medium, a magnetic recording medium, or a semiconductor memory.

For example, when the computer 1000 functions as the control device 100 according to the first embodiment, the CPU 1100 of the computer 1000 executes the program loaded on the RAM 1200 to achieve functions of the movement control unit 110, the arm control unit 111, and the like. The HDD 1400 stores the program related to the present disclosure and the data in the object data storage unit 101, the moving space data storage unit 102, and the main body data storage unit 103. The CPU 1100 reads the program data 1450 from the HDD 1400 and executes it, but as another example, these programs may be acquired from another device via the external network 1550. The program can cause the computer 1000 to execute processing for moving the moving body 1 in a state where at least a part of the object B existing in the moving space RS is inserted to the opening 17 provided in the moving body 1 which can move in the moving space RS.

Note that the present technology can also have the following configurations.

(1)

A moving body comprising:

a main body having an opening; and

a control unit that performs control so that the main body moves in a moving space in a state where at least a part of an object existing in the moving space is inserted to the opening.

(2)

The moving body according to (1),

wherein the object is inserted to the opening so as to overlap at least a part of the main body.

(3)

The moving body according to (1) or (2),

wherein the control unit performs control so that the main body turns around at least a part of a periphery of the object in a state where at least a part of the object is inserted to the opening.

(4)

The moving body according to any one of (1) to (3),

in which a position of the object is fixed in the traveling space.

(5)

The moving body according to any one of (1) to (4),

wherein the object is movable in the moving space, and

the control unit performs control so that the main body rotates in a state where at least a part of the object is inserted to the opening.

(6)

The moving body according to any one of (1) to (5),

wherein the object is movable in the moving space, and

the control unit performs control so that the main body moves in synchronization with the object in a state where at least a part of the object is inserted to the opening.

(7)

The moving body according to (6),

comprising a communication device that communicates with the object,

wherein the control unit performs control so that the main body moves in synchronization with the object based on communication data with the object.

(8)

The moving body according to any one of (1) to (7), comprising:

an object data acquisition unit that acquires object data related to the object;

a moving space data acquisition unit that acquires moving space data related to the moving space; and

a main body data acquisition unit that acquires main body data related to the main body,

wherein the control unit performs control so that at least a part of the object is inserted to the opening based on the object data, the moving space data, and the main body data.

(9)

The moving body according to (8), comprising:

a first determination unit that determines whether a first space larger than a dimension of the main body in a width direction exists in the moving space based on the object data, the moving space data, and the main body data; and

a second determination unit that determines whether a second space through which the main body can pass when at least a part of the object is inserted to the opening exists around the object,

wherein, when the first determination unit determines that the first space does not exist and the second determination unit determines that the second space exists, the control unit performs control so that at least a part of the object is inserted to the opening.

(10)

The moving body according to (9),

wherein, when the first determination unit determines that the first space exists, the control unit performs control so that the main body moves in the first space without inserting the object to the opening, and when the second determination unit determines that the second space does not exist, the control unit performs control so that movement of the main body is stopped.

(11)

The moving body according to any one of (1) to (10),

wherein the main body includes

a frame part, and

a trunk part that is supported by the frame part and to which a robot arm is coupled, and

the opening is provided in the frame part.

(12)

The moving body according to (11),

wherein, in a front-rear direction of the main body, a dimension of the trunk part is smaller than a dimension of the frame part,

the trunk part is arranged in front of a center of the frame part in the front-rear direction, and

the opening is provided at a rear portion of the frame part.

(13)

The moving body according to (11),

wherein a dimension of the trunk part in a front-rear direction is smaller than a dimension of the main body in a width direction.

(14)

The moving body according to (11),

wherein the trunk part is rotatably supported by the frame part, and

the control unit performs control so that the trunk part and the frame part rotate relative to each other in a state where at least a part of the object is inserted to the opening.

(15)

The moving body according to (11),

comprising an arm control unit that performs control so that at least a part of the robot arm moves toward a center of the trunk part when the main body moves in the moving space in a state where at least a part of the object is inserted to the opening.

(16)

The moving body according to any one of (1) to (15),

wherein the main body

includes an insertion space in which the object inserted to the opening is arranged, and

the control unit performs control so that the main body moves in a state where the object inserted to the insertion space and an inner surface of the main body defining the insertion space are separated from each other.

(17)

The moving body according to any one of (1) to (16),

wherein the main body includes

an insertion space in which the object inserted to the opening is arranged, and

a coupling member provided in the insertion space and to which the object is coupled.

(18)

The moving body according to any one of (1) to (17),

wherein the main body includes

an outer surface arranged at least a part of a periphery of the opening, and

an inner surface that defines an insertion space in which the object inserted to the opening is arranged, and

a region of a part of the inner surface including a boundary with the outer surface is inclined towards the opening away from a center of the opening.

(19)

The moving body according to any one of (1) to (18),

wherein the main body includes

an insertion space in which the object inserted to the opening is arranged, and

the insertion space expands toward the opening.

(20)

The moving body according to any one of (1) to (19),

further including a traveling device that travels supporting the main body.

(21)

The moving body according to (20),

in which the traveling device includes omnidirectional moving wheels.

(22)

A control method of a moving body, the control method comprising

moving the moving body in a state where at least a part of an object existing in a moving space is inserted to an opening provided in the moving body that is movable in the moving space.

(23)

A program causing execution of processing of

moving a moving body in a state where at least a part of an object existing in a moving space is inserted to an opening provided in the moving body that is movable in the moving space.

### REFERENCE SIGNS LIST

1 MOVING BODY
1B EXTERNAL MOVING BODY
2 MAIN BODY
5 TRAVELING DEVICE
7 ROBOT ARM
10 FRAME PART
11 TRUNK PART
17 OPENING
18 OUTER SURFACE
19 INSERTION SPACE
20 INNER SURFACE
23 COMMUNICATION DEVICE
100 CONTROL DEVICE
101 OBJECT DATA STORAGE UNIT
102 MOVING SPACE DATA STORAGE UNIT
103 MAIN BODY DATA STORAGE UNIT
104 POSITION DATA ACQUISITION UNIT
105 OBJECT DATA ACQUISITION UNIT
106 MOVING SPACE DATA ACQUISITION UNIT
107 MAIN BODY DATA ACQUISITION UNIT
108 FIRST DETERMINATION UNIT
109 SECOND DETERMINATION UNIT
110 MOVEMENT CONTROL UNIT
111 ARM CONTROL UNIT
112 COMMUNICATION UNIT
CP1 FIRST SPACE
CP2 SECOND SPACE
RS MOVING SPACE
TP MOVING SURFACE

1. A moving body comprising:
a main body having an opening; and
a control unit that performs control so that the main body moves in a moving space in a state where at least a part of an object existing in the moving space is inserted to the opening.

2. The moving body according to claim 1,
wherein the object is inserted to the opening so as to overlap at least a part of the main body.

3. The moving body according to claim 1,
wherein the control unit performs control so that the main body turns around at least a part of a periphery of the object in a state where at least a part of the object is inserted to the opening.

4. The moving body according to claim 1,
wherein the object is movable in the moving space, and
the control unit performs control so that the main body rotates in a state where at least a part of the object is inserted to the opening.

5. The moving body according to claim 1,
wherein the object is movable in the moving space, and
the control unit performs control so that the main body moves in synchronization with the object in a state where at least a part of the object is inserted to the opening.

6. The moving body according to claim 5,
comprising a communication device that communicates with the object,
wherein the control unit performs control so that the main body moves in synchronization with the object based on communication data with the object.

7. The moving body according to claim 1, comprising:
an object data acquisition unit that acquires object data related to the object;
a moving space data acquisition unit that acquires moving space data related to the moving space; and
a main body data acquisition unit that acquires main body data related to the main body,
wherein the control unit performs control so that at least a part of the object is inserted to the opening based on the object data, the moving space data, and the main body data.

8. The moving body according to claim 7, comprising:
a first determination unit that determines whether a first space larger than a dimension of the main body in a width direction exists in the moving space based on the object data, the moving space data, and the main body data; and
a second determination unit that determines whether a second space through which the main body can pass when at least a part of the object is inserted to the opening exists around the object,
wherein, when the first determination unit determines that the first space does not exist and the second determination unit determines that the second space exists, the control unit performs control so that at least a part of the object is inserted to the opening.

9. The moving body according to claim 8,
wherein, when the first determination unit determines that the first space exists, the control unit performs control so that the main body moves in the first space without inserting the object to the opening, and when the second determination unit determines that the second space does not exist, the control unit performs control so that movement of the main body is stopped.

10. The moving body according to claim 1,
wherein the main body includes
a frame part, and
a trunk part that is supported by the frame part and to which a robot arm is coupled, and
the opening is provided in the frame part.

11. The moving body according to claim 10,
wherein, in a front-rear direction of the main body, a dimension of the trunk part is smaller than a dimension of the frame part,
the trunk part is arranged in front of a center of the frame part in the front-rear direction, and
the opening is provided at a rear portion of the frame part.

12. The moving body according to claim 10,
wherein a dimension of the trunk part in a front-rear direction is smaller than a dimension of the main body in a width direction.

13. The moving body according to claim 10,
wherein the trunk part is rotatably supported by the frame part, and
the control unit performs control so that the trunk part and the frame part rotate relative to each other in a state where at least a part of the object is inserted to the opening.

14. The moving body according to claim 10,
comprising an arm control unit that performs control so that at least a part of the robot arm moves toward a center of the trunk part when the main body moves in the moving space in a state where at least a part of the object is inserted to the opening.

15. The moving body according to claim 1,
wherein the main body
includes an insertion space in which the object inserted to the opening is arranged, and
the control unit performs control so that the main body moves in a state where the object inserted to the insertion space and an inner surface of the main body defining the insertion space are separated from each other.

16. The moving body according to claim 1,
wherein the main body includes
an insertion space in which the object inserted to the opening is arranged, and
a coupling member provided in the insertion space and to which the object is coupled.

17. The moving body according to claim 1,
wherein the main body includes
an outer surface arranged at least a part of a periphery of the opening, and
an inner surface that defines an insertion space in which the object inserted to the opening is arranged, and
a region of a part of the inner surface including a boundary with the outer surface is inclined towards the opening away from a center of the opening.

18. The moving body according to claim 1,
wherein the main body includes
an insertion space in which the object inserted to the opening is arranged, and
the insertion space expands toward the opening.

19. A control method of a moving body, the control method comprising
moving the moving body in a state where at least a part of an object existing in a moving space is inserted to an opening provided in the moving body that is movable in the moving space.

20. A program causing execution of processing of
moving a moving body in a state where at least a part of an object existing in a moving space is inserted to an opening provided in the moving body that is movable in the moving space.
